(19) United States
(12) Patent Application Publication
(10) Pub. No.: US 2022/0225794 A1
(43) Pub. Date: Jul. 21, 2022

(54) DISPLAY CONTROL METHOD, DISPLAY CONTROL DEVICE, AND DISPLAY SYSTEM

(71) Applicant: Panasonic Intellectual Property Management Co., Ltd., Osaka (JP)

(72) Inventors: Yuki OHIRA, Tokyo (JP); Takashi TAMURA, Kanagawa (JP)

(21) Appl. No.: 17/579,096

(22) Filed: Jan. 19, 2022

(30) Foreign Application Priority Data
Jan. 19, 2021 (JP) 2021-006408

(51) Int. Cl. A47F 3/04; G06F 1/20

(52) U.S. Cl. CPC A47F 3/0478; G06F 1/206

(57) ABSTRACT

A display control method according to an aspect of the present disclosure includes: judging whether a malfunction has occurred in a cooling system; when it is judged in the judging that a malfunction has occurred in the cooling system, identifying a type of the malfunction based on at least one item of equipment information among items of equipment information obtained from the cooling system and including at least one of measurement information or setting information; determining a display mode for the at least one item of equipment information based on at least one of the type of the malfunction or a factor in identifying the type of the malfunction; and causing a display device to display (i) the at least one item of equipment information in the display mode determined in the determining and (ii) type information indicating the type of the malfunction.

### CROSS REFERENCE TO RELATED APPLICATION

The present application is based on and claims priority of Japanese Patent Application No. 2021-006408 filed on Jan. 19, 2021. The entire disclosure of the above-identified application, including the specification, drawings and claims is incorporated herein by reference in its entirety.

### FIELD

The present disclosure relates to a display control method for controlling a display device, a display control device, and a display system including the display device and the display control device.

### BACKGROUND

PTL 1 discloses a failure analysis device that limits, from data files collected at a factory or the like, a data file set at a certain time after a set event occurs, and identifies a data file corresponding to trigger conditions from data files in the limited data file set. The failure analysis device disclosed in PTL 1 displays the data file corresponding to the trigger conditions and data in data files collected before and after the data file corresponding to the trigger conditions. For example, a user analyzes an equipment malfunction that has occurred in a factory or the like, by confirming displayed data.

### CITATION LIST

### Patent Literature

PTL 1: Japanese Patent No. 3560769

### SUMMARY

### Technical Problem

The present disclosure provides a display control method that can display data in an easier way for a user to understand than the related art.

### Solution to Problem

A display control method according to an aspect of the present disclosure includes: judging whether a malfunction has occurred in a cooling system including a plurality of sensors and cooling equipment; when it is judged in the judging that a malfunction has occurred in the cooling system, identifying a type of the malfunction based on at least one item of equipment information among items of equipment information including at least one of measurement information indicating measurement results of the plurality of sensors or setting information regarding the cooling system, the items of equipment information being obtained from the cooling system; determining a display mode for the at least one item of equipment information based on at least one of the type of the malfunction or a factor in identifying the type of the malfunction; and causing a display device to display (i) the at least one item of equipment information in the display mode determined in the determining and (ii) type information indicating the type of the malfunction.

A display control device according to an aspect of the present disclosure includes: a judging unit that judges whether a malfunction has occurred in a cooling system including a plurality of sensors and cooling equipment; an identifying unit that identifies, when the judging unit judges that a malfunction has occurred in the cooling system, a type of the malfunction based on at least one item of equipment information among items of equipment information including at least one of measurement information indicating measurement results of the plurality of sensors or setting information regarding the cooling system, the items of equipment information being obtained from the cooling system; a determining unit that determines a display mode for the at least one item of equipment information based on at least one of the type of the malfunction or a factor in identifying the type of the malfunction; and a display control unit that causes a display device to display (i) the at least one item of equipment information in the display mode determined by the determining unit and (ii) type information indicating the type of the malfunction.

A display system according to an aspect of the present disclosure includes: the display control device described above; the cooling system; and the display device.

It should be noted that these general and specific aspects may be implemented as a system, a method, an integrated circuit, a computer program, or a computer-readable recording medium such as a CD-ROM, or may be implemented as any combination of a system, a method, an integrated circuit, a computer program, and a recording medium.

### Advantageous Effects

The display control method, etc., according to the present disclosure can display data in an easier way for a user to understand than the related art.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for describing an outline of a display system including a display control device according to an embodiment.

FIG. 2A is a block diagram illustrating a configuration of the display system according to the embodiment.

FIG. 2B is a block diagram illustrating a configuration of cooling equipment according to the embodiment.

FIG. 3 is a cross-sectional view schematically illustrating a configuration of a showcase according to the embodiment.

FIG. 4 is a sequence diagram indicating processing steps of a display system according to the embodiment.

FIG. 5 is a diagram illustrating a user table according to the embodiment.

FIG. 6 is a diagram illustrating a first example of a display method list according to the embodiment.

FIG. 7 is a diagram illustrating a first example of a malfunctioning equipment list according to the embodiment.

FIG. 8 is a flowchart indicating processing steps of the display control device according to the embodiment.

FIG. 9 is a diagram illustrating a first example of a display screen when equipment information is indicated using text characters on a display device according to the embodiment.

FIG. 10 is a diagram illustrating a second example of a display screen when equipment information is indicated using text characters on the display device according to the embodiment.

FIG. 11 is a diagram illustrating a first example of a display screen when equipment information is indicated using a graph on the display device according to the embodiment.

FIG. 12 is a diagram illustrating a first example of a display screen when equipment information is indicated using a chart on the display device according to the embodiment.

FIG. 13 is a flowchart indicating the processing steps of the display device according to the embodiment.

FIG. 14 is a flowchart indicating details of display processing of detailed information performed by the display device according to the embodiment.

FIG. 15 is a diagram illustrating a second example of a display screen when equipment information is indicated using a graph on display device according to the embodiment.

FIG. 16 is a diagram illustrating a third example of a display screen when equipment information is indicated using a graph on the display device according to the embodiment.

FIG. 17 is a diagram illustrating a fourth example of a display screen when equipment information is indicated using a graph on the display device according to the embodiment.

FIG. 18 is a diagram illustrating an example of a display screen that is displayed when the display device according to the embodiment receives an instruction to add a display item set.

FIG. 19 is a diagram illustrating a second example of a display method list according to the embodiment.

FIG. 20 is a diagram illustrating an example of a display screen to be displayed when the display device according to the embodiment receives a change of a first display screen to be displayed according to the type of a malfunction.

FIG. 21 is a diagram illustrating a third example of a display method list according to the embodiment.

FIG. 22 is a diagram illustrating an example of a display screen to be displayed upon receipt of registration of image data on the display screen displayed by the display device according to the embodiment.

FIG. 23 is a diagram illustrating a second example of a malfunctioning equipment list according to the embodiment.

FIG. 24 is a flowchart indicating the details of display processing of registered image data performed by the display device according to the embodiment.

FIG. 25 is a diagram illustrating a third example of a display screen when equipment information is indicated using text characters on the display device according to the embodiment.

FIG. 26 is a diagram illustrating an example of a measurement result of a sensor when equipment information is displayed using text characters on the display device according to the embodiment.

FIG. 27 is a diagram illustrating a fifth example of a display screen when equipment information is indicated using a graph on the display device according to the embodiment.

FIG. 28 is a diagram illustrating a sixth example of a display screen when equipment information is indicated using a graph on the display device according to the embodiment.

FIG. 29 is a diagram illustrating a second example of a display screen when equipment information is indicated using a chart on the display device according to the embodiment.

FIG. 30 is a diagram illustrating a third example of a display screen when equipment information is indicated using a chart on the display device according to the embodiment.

FIG. 31 is a flowchart indicating processing steps of a display control method according to the embodiment.

### DESCRIPTION OF EMBODIMENT

### Underlying Knowledge Forming Basis of the Present Disclosure

Conventionally, there are equipment for which equipment related information (more specifically, information about the status of the equipment) such as temperature, etc, is measured. For example, a device is provided to display a display screen indicating a temperature measured by a sensor, on a display, when the temperature measured by the sensor indicates an abnormal value. A user (operator) identifies the type (cause) of a malfunction occurring in the equipment by confirming data on the display format (display mode) of, for example, a graph or a chart that is displayed on the display device.

When a large amount of data is displayed on the display device in the event that a malfunction has occurred in the equipment, it takes quite a long time for the user to identify the type of the malfunction, preventing the user from quickly and properly repairing the equipment.

For example, even if a device is available to identify the type of a malfunction occurring in the equipment by analyzing information measured by the sensor and display one or more candidates of the type of the identified malfunction on the display device, it takes time for the user to determine which data to examine and which part of the device is to be repaired.

Thus, a conventional device is provided to display, from among data segments measured by the sensor, only data measured in a predetermined period around the time of measurement of abnormal information by the sensor. This configuration does not display data that is unlikely to be necessary for the identification of the type of the malfunction by the user. Thus, the user can confirm only data that is likely to be necessary for the identification of the type of the malfunction, thereby shortening a working time for identifying the type of the malfunction.

Some malfunction types can be identified from a smaller amount of data (for example, only data on the instantaneous values of sensors). In this case, it takes a long time to display data in the predetermined period. Furthermore, it is time-consuming for the user to determine, for example, a remarkable point and identify the type of a malfunction.

As a result of diligent study, the inventors have found a method for displaying data (measurement information about the results of measurements by a sensor) on a display device such that the type of malfunction occurring in equipment is more easily understood by the user, that is, the type of the malfunction occurring in the equipment is more easily identified by the user than in the related art.

Hereinafter, an exemplary embodiment will be described in detail with reference to the Drawings. However, overly detailed description may be omitted. For example, detailed description of well-known matter and overlapping description of substantially identical elements may be omitted. This is done to avoid the following description from being unnecessarily redundant, and to facilitate understanding by those skilled in the art.

It should be noted that the accompanying Drawings and the following description are provided by the inventors in order for those skilled in the art to sufficiently understand the present disclosure, and thus are not intended to limit the subject matter of the Claims.

### Embodiment

### Configuration

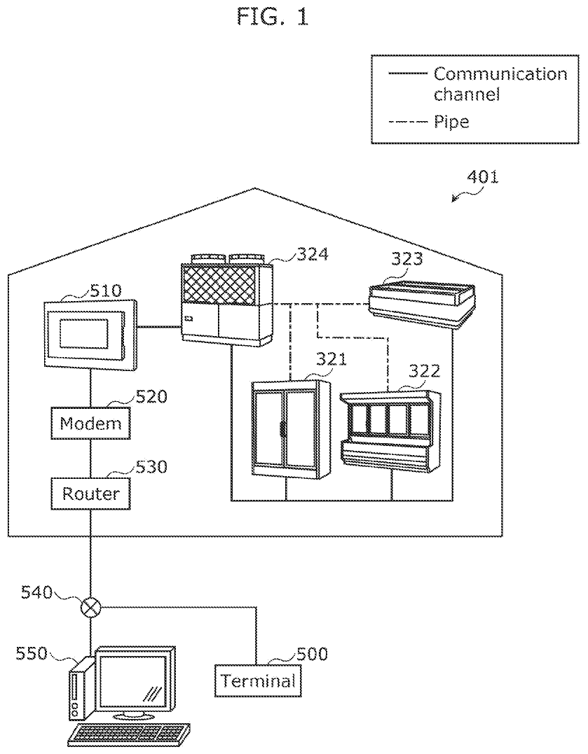

FIG. 1 is a diagram for describing an outline of display system 401 including a display control device according to an embodiment.

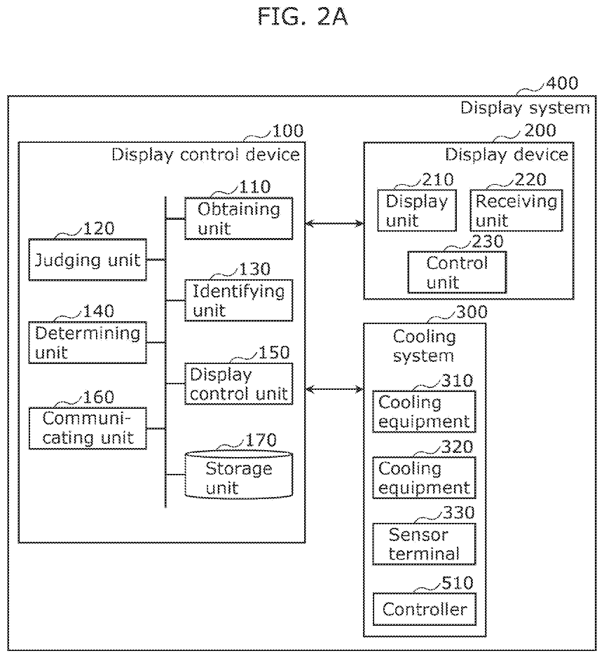

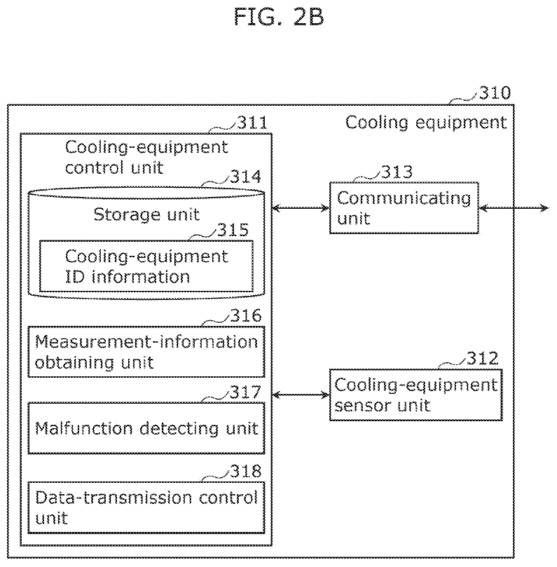

In the example of FIG. 1, for example, display control device 100 according to the embodiment of FIG. 2A, which will be described later, is server device 550. Moreover, for example, display device 200 according to the embodiment of FIG. 2A, which will be described later, is terminal 500.

A display system according to the embodiment is a maintenance inspection system that obtains, when a malfunction occurs in a cooling system including cooling equipment and equipment necessary for operating the cooling equipment, such as a controller, pipes, and a communication line, equipment information that is at least one of measurement results and setting information, the measurement result being obtained by the cooling equipment and a plurality of sensors that are disposed in the cooling equipment and measure information including a temperature, a pressure, a current value, or a voltage value, the setting information indicating a set value when the cooling equipment and the cooling equipment operate. When at least one of the sensors measures abnormal information, the system identifies the type of a malfunction based on the obtained measurement result according to a predetermined identification method and causes a display device to display measurement information, which indicates the state of the equipment, in a specific display mode based on the identification result (that is, the type of the malfunction) and a factor in identifying a malfunction (e.g., the identification method).

In the example of FIG. 1, display system 401 according to the embodiment includes refrigerating machine 324, showcases 321, 322, and 323, controller 510, modem 520, router 530, server device 550, and terminal 500.

Controller 510 and server device 550 are connected to each other so as to communicate via modem 520, router 530, e.g., a virtual private network (VPN) router, and network 540, e.g., the Internet. Moreover, server device 550 and terminal 500 are connected to each other so as to communicate via network 540.

The connection relation among the communication channels of the equipment is not limited thereto. For example, the equipment may be connected so as to directly communicate with network 540.

Display system 401 needs not include modem 520 and router 530. In this case, controller 510 may be connected to directly communicate with server device 550 by using, for example, a communication subscriber identity module (SIM) for a mobile virtual network operator (MVNO).

Refrigerating machine 324 is an apparatus for supplying a refrigerant into showcases 321, 322, and 323. Refrigerating machine 324 is connected to showcases 321, 322, and 323 via pipes for passing the refrigerant. Showcases 321, 322, and 323 each have a sensor, which is not illustrated. For example, a system (an equipment group such as refrigerating machine 324 and showcases 321, 322, and 323 that are connected via pipes (refrigerant pipes)) provided for display system 401 is connected to perform communications such that measurement results obtained by the sensors are transmitted to server device 550.

The communication channel that connects the respective equipment to allow communication may a wired or wireless communication channel.

FIG. 2A is a block diagram illustrating a configuration of display system 400 according to the embodiment. Display system 401 is a specific example of display system 400.

Display system 400 includes display control device 100, display device 200, and cooling system 300.

Display system 400 may further include constituent elements such as modem 520 illustrated in FIG. 1. These constituent elements are not illustrated in FIG. 2A.

Display control device 100 identifies, when it is judged that a malfunction has occurred in cooling system 300, the type of the malfunction in cooling system 300 based on at least one of the items of equipment information regarding cooling system 300, the equipment information being obtained from cooling system 300. Display control device 100 determines a display mode to be displayed by display device 200 regarding the at least one item of the equipment information used for identifying the type of the malfunction and causes display device 200 to display the equipment information in the determined display mode.

The equipment information is information about cooling system 300. For example, the equipment information includes measurement information indicating the measurement results of the sensors, the measurement results being obtained from the sensors (specifically, sensors provided for cooling-equipment sensor unit 312 that is included in cooling equipment 310 and will be described later) provided for the cooling system (more specifically, cooling equipment 310 and cooling equipment 320) and setting information indicating set values for cooling system 300 (more specifically, cooling equipment 310 and cooling equipment 320). The set values for cooling equipment 310 and 320 are, for example, an inside temperature or a current value for driving refrigerating machine 324. For example, cooling equipment 310 and 320 operate to have the set values. Cooling equipment 310 and 320 obtain, for example, setting information about the set value of an inside temperature from the user via controller 510 having a user interface, store the information, and perform control based on the obtained setting information.

Inside the equipment means the internal space of a housing for placing fresh foods or the like in showcases 321, 322, and 323.

For example, display control device 100 determines a display mode to be displayed by display device 200 regarding the measurement information about the measurement results of the sensors, the measurement results being obtained from the sensors provided for cooling equipment 310. Display control device 100 causes display device 200 to display the measurement information in the determined display mode. Display control device 100 is, for example, a computer (server device 550 in FIG. 1 in the present embodiment) that is connected so as to communicate with display device 200 and cooling system 300. The computer is implemented by, for example, a communication interface for communications with display device 200 and cooling system 300, nonvolatile memory that stores programs, volatile memory serving as a temporary storage area for running the programs, an input/output port for transmitting and receiving signals, and a processor for running the programs.

Display control device 100 includes obtaining unit 110, judging unit 120, identifying unit 130, display control unit 150, communicating unit 160, and storage unit 170.

Obtaining unit 110 is a processing unit for obtaining equipment information indicating information about cooling system 300. For example, obtaining unit 110 obtains measurement results (measurement data) obtained by the sensors and setting information indicating set values for cooling system 300 (e.g., cooling equipment 310 and 320), as equipment information from cooling system 300 (more specifically, the sensors provided for cooling system 300). The sensors provided for cooling system 300 are, for example, sensors provided for cooling-equipment sensor unit 312 included in cooling equipment 310 and/or sensors provided for sensor terminal 330.

For example, obtaining unit 110 obtains the equipment information via communicating unit 160. The obtained equipment information is stored in storage unit 170. For example, obtaining unit 110 also obtains data including a pressure value of cooling equipment 320 (e.g., refrigerating machine 324) provided for cooling system 300 along with data measured by the sensors provided for cooling system 300, as measurement information from cooling equipment 310 and 320. Furthermore, obtaining unit 110 obtains setting information from, for example, controller 510 and cooling equipment 310 and 320.

The setting information may be stored in advance in storage unit 170. In this case, obtaining unit 110 may obtain the setting information from storage unit 170.

Judging unit 120 is a processing unit for judging whether a malfunction has occurred in cooling system 300. For example, when warning data indicating the occurrence of a malfunction in cooling system 300 is received from cooling system 300, judging unit 120 judges that a malfunction has occurred in cooling system 300.

The warning data may be transmitted from a device other than cooling system 300, for example, display device 200 or may be received via an input unit (not illustrated), e.g., a keyboard provided to receive a user input in display control device 100.

For example, by analyzing items of equipment information obtained by obtaining unit 110, judging unit 120 may judge that a malfunction has occurred in cooling system 300 when the analysis result satisfies predetermined conditions.

Identifying unit 130 is a processing unit that identifies, when judging unit 120 judges that a malfunction has occurred in cooling system 300. Here, the type of the malfunction is based on at least one of the items of the equipment information regarding cooling system 300. The equipment information is obtained from cooling system 300. As described above, for example, cooling equipment 310 and 320 provided in cooling system 300 each include a plurality of sensors, and items of measurement information include a plurality of measurement results obtained by the sensors. In this case, for example, identifying unit 130 identifies, when judging unit 120 judges that a malfunction has occurred in cooling equipment 310 and 320, the type of the malfunction based on at least one of the measurement results obtained by the sensors.

The type of a malfunction means a cause of a malfunction that has occurred in cooling system 300. For example, the cause is a failure of a component, e.g., a sensor provided for cooling equipment 310, a poor status of cooling equipment 310, e.g., an opened door on a housing provided for cooling equipment 310, or an abnormality in a set value that is set to cooling equipment 310 and 320.

When cooling system 300 includes pieces of cooling equipment, each piece of the cooling equipment may include one or more sensors.

Determining unit 140 is a processing unit that determines the display mode of at least one item of the equipment information used for identifying the type of a malfunction, based on at least one of the malfunction type identified by identifying unit 130 and a factor for identifying the type of the malfunction.

The factor in identifying the type of a malfunction is an element used for identifying the malfunction by identifying unit 130, that is, a reason for deriving the type of the malfunction. The factor in identifying the type of a malfunction is, for example, information about at least one item of equipment information used for identifying the type of the malfunction and/or a predetermined judging method used for identifying the type of the malfunction.

The information about the at least one item of equipment information is, for example, information about the type of equipment information such as a temperature and a current value and the number of items of equipment information.

The predetermined judging method is a judging method for identifying the type of a malfunction when the equipment information satisfies the predetermined judging conditions.

For example, a plurality of judging methods for identifying the type of a malfunction are stored in advance in storage unit 170. Malfunction types are associated with the plurality of judging methods. Identifying unit 130 analyzes the equipment information by using the judging methods, identifies the type of a malfunction corresponding to the judging method satisfying the judging conditions, and specifies the identified malfunction type as the type of a malfunction that has occurred in cooling system 300.

For example, when a first judging method is a judging method for judging whether a first judging condition is satisfied or not and when the measurement information satisfies the first judging condition, identifying unit 130 identifies a first type as the type of a malfunction. Alternatively, for example, when a second judging method is a judging method for judging whether a second judging condition different from the first judging condition is satisfied or not and when the measurement information satisfies the second judging condition, identifying unit 130 identifies a second type, which is different from the first type, as the type of a malfunction.

For example, a plurality of judging methods for identifying the type of a malfunction are stored in advance in storage unit 170. The judging methods are each used for identifying, as the type of a malfunction that has occurred in cooling system 300, at least one of the types of anomalies that are likely to occur in cooling system 300. The types of anomalies are associated with the respective judging methods. Identifying unit 130 analyzes the measurement information by using the judging methods, identifies the type of a malfunction corresponding to the judging method satisfying the judging conditions, and specifies the identified malfunction type as the type of a malfunction that has occurred in cooling system 300.

The judging methods stored in storage unit 170 are not particularly limited and may be optionally determined in advance.

The display mode of the equipment information is the way to display (display method) by display device 200. More specifically, the display mode of the equipment information is, for example, how to indicate values on a display screen when display device 200 is caused to display the values of data serving as measurement information that is an example of the equipment information. The display mode is, for example, a text character, a graph, or a chart. A character display mode indicates, for example, display only including text characters (character strings) without ruled lines or coordinate axes. As a matter of course, in the character display mode, equipment information may be displayed with text characters. For example, when information other than the equipment information, e.g., an icon for receiving a user input is included in a display screen containing the equipment information, ruled lines or the like may be used for information other than the measurement information.

For example, determining unit 140 determines the display mode based on the type of a malfunction. For example, when the type of the malfunction is a set temperature abnormality (i.e., setting information abnormality) of cooling equipment 310, determining unit 140 determines the character display mode (more specifically, only character strings). For example, when the sensor is a temperature sensor, any anomalies such as a failure are not identified in the sensor, and a temperature as the measurement result of the sensor and a set temperature in cooling equipment 310 are equal to each other, identifying unit 130 identifies the set temperature abnormality (i.e., setting information abnormality) as the type of a malfunction.

Alternatively, determining unit 140 determines the display mode based on a factor in identifying the type of a malfunction by identifying unit 130.

For example, when a factor in identifying the type of a malfunction is at least one measurement result that is used for identifying the type of the malfunction by identifying unit 130 and is greater than or equal to a first threshold value, determining unit 140 determines the display mode such that the type of the sensor that has generated the at least one measurement result and the largest value of the at least one measurement result which is greater than or equal to the first threshold value are indicated using text characters (more specifically, only text characters).

For example, in the event of a failure of the sensor, an extremely high value may be outputted as a measurement result. In this case, for example, determining unit 140 displays, as text characters, the type of the sensor and the measurement result indicating the largest value among abnormal values detected by the sensor.

Alternatively, for example, when a factor in identifying the type of a malfunction is at least one measurement result that is used for identifying the type of the malfunction by identifying unit 130 and is less than or equal to a second threshold value, determining unit 140 determines the display mode such that the type of the sensor that has generated the at least one measurement result and the smallest value of the at least one measurement result which is less than or equal to the second threshold value are indicated using text characters (more specifically, only text characters).

For example, in the event of a failure of the sensor, an extremely small value may be outputted as a measurement result. In this case, for example, determining unit 140 displays, as text characters, the type of the sensor and the measurement result indicating the smallest value among abnormal values detected by the sensor.

Alternatively, for example, when a factor in identifying the type of a malfunction is that a value serving as a result of measurement by a first sensor among the plurality of sensors provided for cooling equipment 310 and 320 does not reach a third threshold value in a first predetermined period, determining unit 140 determines the display mode such that the values of results of measurements by the first sensor in the first predetermined period and the third threshold value are indicated using a graph. For example, a temperature in showcase 321 may fail to reach the set value (that is, the temperature may fail to decrease to the set value) due to frost (more specifically, frost formed in the showcase). In this case, for example, determining unit 140 determines the display mode such that the values of results of measurements (e.g., time series data) by the first sensor (e.g., the sensor for measuring an inside temperature) and the third threshold value are indicated using a graph.

Alternatively, for example, when a factor in identifying the type of a malfunction is based on a correlation between a change of a value over time, which is a result of measurement by a second sensor among the plurality of sensors, and a change of a value over time, which is a result of measurement by a third sensor different from the second sensor among the plurality of sensors, determining unit 140 determines the display mode such that the change of the value over time, which is the result of measurement by the second sensor, and the change of the value over time, which is the result of measurement by the third sensor, are indicated using a graph. For example, as illustrated in FIG. 12, which will be described later, when the type of a malfunction is identified by identifying unit 130 based on the measurement results of the sensors that are different from one another (in FIG. 12, measurements are performed at different positions such as an evaporator inlet, an evaporator outlet, and the inside of the equipment), determining unit 140 determines the display mode such that the measurement results of the sensors are displayed using a chart by display device 200.

For example, the third sensor different from the second sensor may measure a different kind of information (e.g., a temperature, a current, or a pressure) from the second sensor or measure the same kind of information as the second sensor at a different measurement position from the second sensor.

Alternatively, for example, when a factor in identifying the type of a malfunction is based on a comparison between the result of measurement by a fourth sensor among the plurality of sensors provided for cooling equipment 310 and 320 and the result of measurement by a fifth sensor different from the fourth sensor among the plurality of sensors provided for cooling equipment 310 and 320, at a predetermined time, determining unit 140 determines the display mode such that a value which is the result of measurement by the fourth sensor and a value which is the result of measurement by the fifth sensor are indicated using a chart. Specifically, for example, in a judging method based on a comparison between the result of measurement by the fourth sensor at the predetermined time and the result of measurement by the fifth sensor at the predetermined time, determining unit 140 determines the display mode such that a value which is the result of measurement by the fourth sensor and a value which is the result of measurement by the fifth sensor are indicated using a chart. For example, the measurement results may correlate with each other like an operation change of a thermostat and a change of an inside temperature. In this configuration, the thermostat is, for example, a solenoid valve for turning on or off the supply of cold air into the storage part (inside) of showcase 321. For example, when the thermostat is turned on, an inside temperature considerably decreases. In this way, for example, when a factor identified by identifying unit 130 as the cause of a malfunction that has occurred in cooling equipment 310 and 320 is missing coordination between the measurement result of the fourth sensor and the measurement result of the fifth sensor, the measurement result changing in synchronization with the measurement result of the fourth sensor, determining unit 140 displays the measurement result of the fourth sensor and the measurement result of the fifth sensor as graphs.

The predetermined time may be any time.

For example, the fifth sensor different from the fourth sensor may measure a different kind of information (e.g., a temperature, a current, or a pressure) from the fourth sensor or measure the same kind of information as the fourth sensor at a different measurement position from the fourth sensor.

The threshold values may be stored in advance in storage unit 170 and may be optionally determined.

Alternatively, for example, when a factor in identifying the type of a malfunction is only one item of measurement information at a moment among the items of measurement information, determining unit 140 may determine the display mode such that the measurement information is indicated using text characters, and when a factor in identifying the type of a malfunction is two or more items of measurement information among the items of measurement information, determining unit 140 may determine the display mode such that the measurement information is indicated using a graph or a chart. As described above, for example, the display mode may be determined based on a value indicated by the measurement information in the case of judgment using threshold values, or the display mode may be determined based on the number of items of the measurement information.

For example, when the type of a malfunction is a setting information abnormality, determining unit 140 determines the display mode such that the setting information is indicated using text characters.

For example, when a factor in identifying the type of a malfunction is that two or more measurement results at different times are obtained by one of the sensors provided for cooling equipment 310 and 320, determining unit 140 determines the display mode such that the measurement information is indicated using a graph. In other words, when the type of a malfunction is identified by time series data, the measurement information may be displayed as a graph. For example, when a factor in identifying the type of a malfunction is two or more of the measurement results among the plurality of measurement results, determining unit 140 may determine a graph display mode when the two or more items of the measurement information include time series data measured by one of the sensors at different times, or determining unit 140 may determine a chart display mode when the two or more items of the measurement information are not time series data but a piece of data measured by each of the sensors.

In this way, the display mode may be determined by, for example, the number of sensors that generate the measurement results used for identifying the type of a malfunction, and the type of sensors.

For example, determining unit 140 may determine the display mode based on a display method list in which the type of a malfunction (“Diagnosis result” in FIG. 6) and a display mode (“Display” in FIG. 6) are associated with each other in FIG. 6. The display method list will be described later. The display method list may be stored in storage unit 170.

Display control unit 150 is a processing unit that causes display device 200 to display, in the display mode determined by determining unit 140, at least one item of the equipment information as a factor in identifying the type of a malfunction by identifying unit 130 and to display type information indicating the type of the malfunction. For example, display control unit 150 causes display device 200 to display the equipment information in the display mode determined by determining unit 140 and the type information, by transmitting information (an example of detailed information) including the equipment information and the type information to display device 200 via communicating unit 160. In this case, display device 200 displays, based on the received detailed information, a display screen including the equipment information in the display mode determined by determining unit 140 and the type information indicating the type of a malfunction.

Alternatively, display control unit 150 generates, for example, image data (another example of detailed information) including the equipment information in the display mode determined by determining unit 140 and the type information indicating the type of a malfunction, and transmits the generated image data to display device 200 via communicating unit 160, causing display device 200 to display an image of image data including the measurement information in the display mode determined by determining unit 140 and the type information.

In the present embodiment, an image is described as an image of image data in a data format such as jpeg. Moreover, an image indicated on the display will be described as “display screen.”

The processing units (obtaining unit 110, judging unit 120, identifying unit 130, and display control unit 150) are each implemented by, for example, a control program stored in storage unit 170 and a central processing unit (CPU) for executing the control program.

Communicating unit 160 is a communication interface for communications with display device 200 and cooling system 300. For example, communicating unit 160 is implemented by a communication connector, which is connected to a communication line, in wire communications with display device 200 and cooling system 300 (e.g., cooling equipment 310 provided for cooling system 300). Alternatively, for example, communicating unit 160 is implemented by an antenna and a radio communication circuit in radio communications with display device 200 and cooling system 300.

Storage unit 170 is, for example, a recorder for recording the control program to be executed by the processing units provided for display control device 100 and measurement results obtained from the sensors. Storage unit 170 is, for example, a flash memory or a hard disk drive (HDD).

Display device 200 is a display device for displaying the equipment information in the display mode specified from display control device 100. Display device 200 includes, for example, a display for displaying a display screen of a liquid crystal display or an organic electroluminescence (EL) display. In the present embodiment, display device 200 is terminal 500 in FIG. 1, e.g., a smartphone or a tablet. Terminal 500 is implemented by, for example, a display for displaying a display screen, a communication interface for communications with display control device 100, nonvolatile memory that stores programs, volatile memory serving as a temporary storage area for running the programs, an input/output port for transmitting and receiving signals, and a processor for running the programs.

Display device 200 includes display unit 210, receiving unit 220, and control unit 230.

Display unit 210 is a display for displaying a display screen.

Receiving unit 220 is a user interface, for example, a keyboard that receives a user instruction (operation) or a mouse.

For example, display unit 210 and receiving unit 220 may be combined by a touch panel display or the like. Hereinafter, display device 200 includes a touch panel display in which display unit 210 and receiving unit 220 are combined.

Control unit 230 is a processing unit for controlling respective devices included in display device 200. For example, control unit 230 causes display unit 210 to display the measurement information with the specified display mode and the type information indicating the type of a malfunction, the measurement information and type information being transmitted from display control device 100.

Control unit 230 is implemented by, for example, a control program stored in memory, which is not illustrated, and a CPU for executing the control program.

Cooling system 300 is a system for supplying cold air to a predetermined location. Specifically, cooling system 300 is a system including cooling equipment 310 and 320 and equipment necessary for operating cooling equipment 310 and 320, such as controller 510 (see FIG. 1), a pipe, and a communication line.

Cooling system 300 includes, for example, cooling equipment 310, cooling equipment 320, sensor terminal 330, and controller 510.

Each of cooling equipment 310 and 320 is disposed in, for example, buildings such as a supermarket in order to supply cold air to positions where fresh foods or the like are placed. Cooling equipment 310 is, for example, a showcase like showcase 321 in FIG. 1. Cooling equipment 320 is, for example, refrigerating machine 324 in FIG. 1.

FIG. 2B is a block diagram illustrating a configuration of cooling equipment 310 according to the embodiment. For example, cooling equipment 320 has substantially the same configuration as cooling equipment 310. Cooling equipment 310 will be specifically discussed below.

Cooling equipment 310 includes cooling-equipment control unit 311, cooling-equipment sensor unit 312, and communicating unit 313.

Cooling-equipment control unit 311 includes a computer having a processor, e.g., a CPU or a micro processor unit (MPU) and memory devices such as a read-only memory (ROM) and a random-access memory (RAM). The computer controls the units of cooling equipment 310.

Cooling-equipment sensor unit 312 includes one or more sensors and measures various kinds of information provided for monitoring an operating state of cooling equipment 310. Such information includes at least inside temperature information. In the present embodiment, the information measured by cooling-equipment sensor unit 312 is referred to as measurement information.

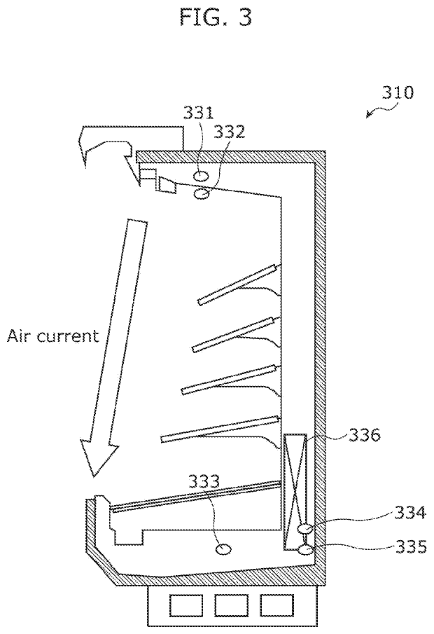

In the present embodiment, cooling-equipment sensor unit 312 includes outlet temperature sensor 331, inside temperature sensor 332, inlet temperature sensor 333, evaporator-inlet temperature sensor 334, and evaporator-outlet temperature sensor 335 in FIG. 3, which will be described later.

Communicating unit 313 transmits and receives information to and from controller 510 via a network and includes a transceiver having a receiving circuit and a transmitting circuit.

Cooling-equipment control unit 311 acts as storage unit 314, measurement-information obtaining unit 316, malfunction detecting unit 317, and data-transmission control unit 318 when a program recorded in a memory device is executed by a processor.

Storage unit 314 stores various kinds of information and stores cooling-equipment ID information 315 in advance. Cooling-equipment ID information 315 uniquely identifies at least the equipment (cooling equipment 310).

Measurement-information obtaining unit 316 periodically obtains the measurement information from cooling-equipment sensor unit 312 at suitable periods.

Malfunction detecting unit 317 detects a malfunction in the operation of cooling equipment 310 based on the measurement information. Specifically, conditions (e.g., a threshold value or a numerical range) regarded as being abnormal are set as malfunction judgment information in advance by a physical quantity, a physical property, and a characteristic that are indicated by the measurement information. Malfunction detecting unit 317 detects a malfunction based on the measurement information and the malfunction judgment information each time the measurement information is obtained.

Malfunction detecting unit 317 may be provided for other devices, for example, controller 510 or display control device 100 instead of cooling equipment 310.

Each time the measurement information obtained by measurement-information obtaining unit 316 is transmitted to controller 510, data-transmission control unit 318 adds cooling-equipment ID information 315 and other appropriate information to the measurement information and transmits the information as operation data to controller 510 via communicating unit 313. When malfunction detecting unit 317 detects a malfunction, data-transmission control unit 318 adds cooling-equipment ID information 315 and other appropriate information to the result of the detection of the malfunction and transmits the result as warning data to controller 510 via communicating unit 313. The detection result of the malfunction includes at least an error code indicating the malfunction.

FIG. 3 is a cross-sectional view schematically illustrating a configuration of the showcase (cooling equipment 310) according to the embodiment.

As illustrated in FIG. 3, a housing provided for cooling equipment 310 contains, for example, outlet temperature sensor 331, inside temperature sensor 332, inlet temperature sensor 333, evaporator-inlet temperature sensor 334, evaporator-outlet temperature sensor 335, and evaporator 336.

Outlet temperature sensor 331 is a temperature sensor that is disposed at the position of an opening for blowing air cooled by evaporator 336 in cooling equipment 310.

Inside temperature sensor 332 is a temperature sensor that is disposed in cooling equipment 310 containing articles.

Inlet temperature sensor 333 is a temperature sensor that is disposed, in cooling equipment 310, at the position of an inlet where cold air from the outlet is drawn after cooling the inside of the equipment.

Evaporator-inlet temperature sensor 334 is a sensor for measuring the temperature of a refrigerant that is fed into cooling equipment 310 from cooling equipment 320 through a pipe.

Evaporator-outlet temperature sensor 335 is a sensor for measuring the temperature of a refrigerant that is fed into cooling equipment 320 from cooling equipment 310 through a pipe.

Referring to FIG. 2A again, sensor terminal 330 is a device including a sensor for measuring information. Sensor terminal 330 measures, for example, the states of the equipment, pipes, and communication lines of cooling system 300, and transmits the measurement results to controller 510.

Cooling system 300 may be provided with a plurality of sensor terminals 330 or single sensor terminal 330.

Sensor terminal 330 may include any type of sensor. The type of sensor is not particularly limited.

FIG. 2A illustrates single cooling equipment 310 as a showcase for cooling system 300. A plurality of showcases may be provided like showcases 321, 322, and 323 in FIG. 1.

For example, when cooling system 300 includes a plurality of showcases serving as cooling equipment 310 connected to the same refrigerating machine (e.g., cooling equipment 320), each of the showcases includes a sixth sensor for measuring the same type of information among the sensors provided for cooling system 300. In this case, for example, when a factor in identifying the type of a malfunction by identifying unit 130 is a comparison result of measurement results obtained from the sixth sensors disposed in the showcases, determining unit 140 determines the display mode such that the values of the measurement results obtained from the sixth sensors are indicated using a chart.

The sensor for measuring the same type of information may be any type of sensor, for example, a temperature sensor, a current sensor, or a pressure sensor.

The first sensor, the second sensor, the third sensor, the fourth sensor, the fifth sensor, and the sixth sensor may be identical sensors or different sensors.

Cooling equipment 320 is, for example, refrigerating machine 324. The temperature of air cooled by refrigerating machine 324 is not particularly limited.

### Operation

The operations of display system 400 configured thus will be described below.

### Processing by Display System

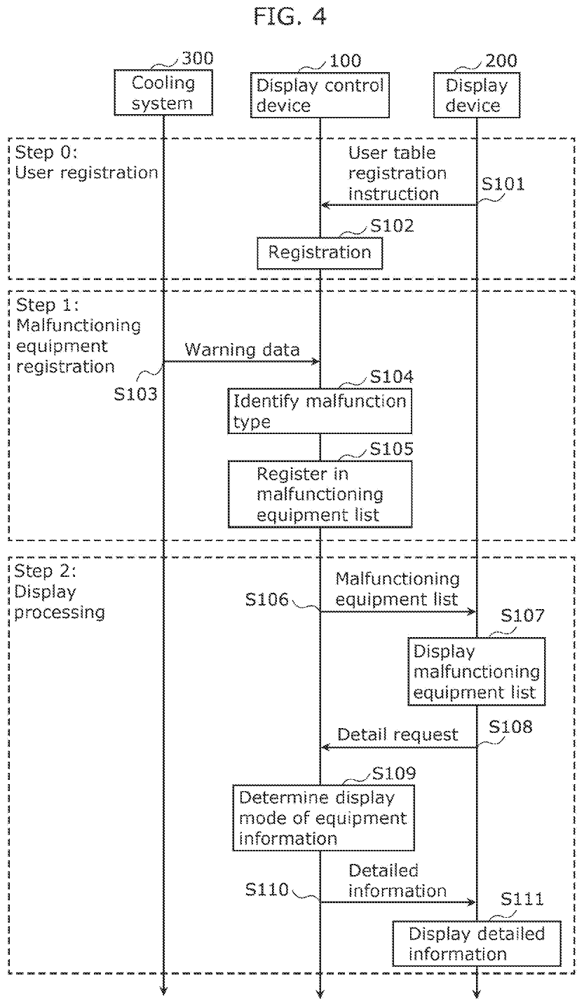

FIG. 4 is a sequence diagram indicating the processing steps of display system 400 according to the embodiment.

First, the registration of user information (step 0: user registration) by display control device 100 will be described below.

Display device 200 receives user information, which indicates a user name and the presence or absence of administrator authority, from the user and transmits information about a user table registration instruction to display control device 100, so that display control device 100 is instructed to register the received user information (S101).

Subsequently, display control device 100 registers the information about the user table registration instruction in a user table, the information being transmitted from display device 200 (S102).

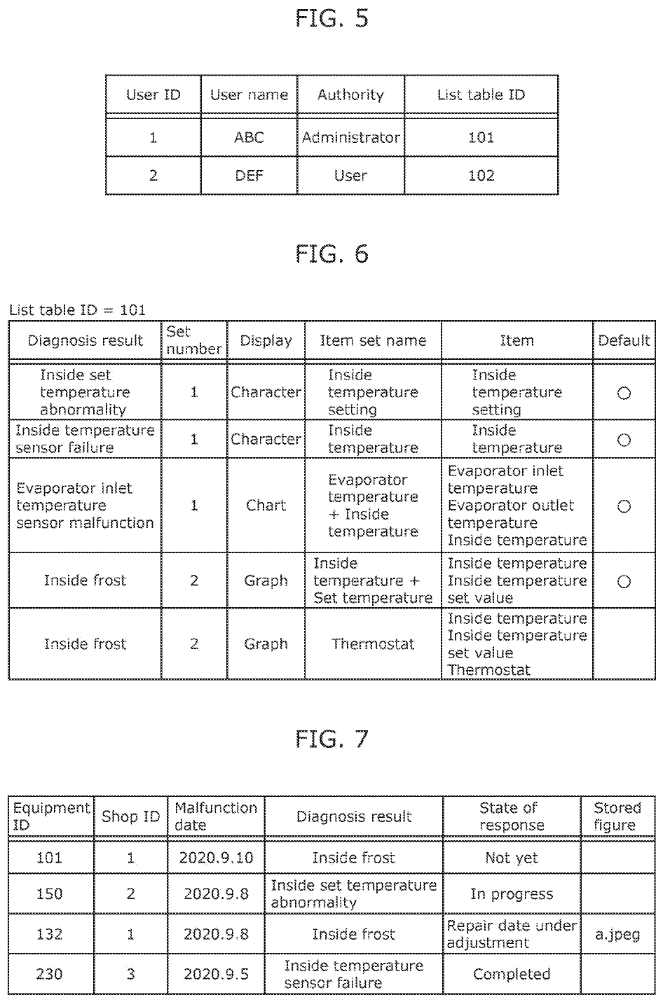

FIG. 5 is a diagram illustrating the user table according to the embodiment.

The user table (user table information) is stored in, for example, storage unit 170 provided for display control device 100.

The user table includes, for example, information about a user ID, information about a user name, information about authority, and information about a list table ID.

The user ID is an identifier specific to each user.

The user name is a name optionally determined by the user.

The information about authority is information about the range of a setting change (update) by the user. For example, a user authorized to act as “administrator” can change the contents of the stored list tables of all users in display control device 100. For example, a user authorized to act as “user” can change only the contents of the stored list table of the user in display control device 100.

The list table ID is an identifier specific to each list table stored in storage unit 170.

For example, a user name “ABC” with a user ID “1” is authorized to act as “administrator” and is registered in the list table while being associated with a list table with a list table ID “101.”

FIG. 6 is a diagram illustrating a first example of a display method list according to the embodiment.

The display method lit is information indicating the display mode for displaying the equipment information including the measurement results of the sensors and the set values. For example, the display method list is associated with a list table ID and is stored in storage unit 170. FIG. 6 indicates a display method list with a list table ID “101.”

The display method list includes, for example, information about the type of a malfunction (“Diagnosis result” in FIG. 6), information about the number of sets, information about display modes (“Display” in FIG. 6), information about item set names, information about items, and information about the presence or absence of a default setting.

The information about the type of a malfunction is information indicating the type of a malfunction that has occurred in cooling system 300, the type being identified by identifying unit 130. For example, FIG. 6 indicates “Inside set temperature abnormality,” “Inside temperature sensor failure,” “Evaporator inlet temperature sensor malfunction,” and “Inside frost” as examples of a malfunction type.

The number of sets is the number of combinations of display modes or items for the type of a malfunction. In the example of

FIG. 6, the number of combinations of display modes or items is one for “Inside set temperature abnormality,” the type of a malfunction, so that the number of sets is “1”. In the example of FIG. 6, the number of combinations of display modes or items is two for “Inside frost,” the type of a malfunction, so that the number of sets is “2”.

The information about the display mode is information indicating a mode for displaying the measurement information by display device 200. For example, the measurement information is indicated by text characters in the “Character” display mode, the measurement information is indicated by a chart in the “Chart” display mode, and the measurement information is indicated by a graph in the “Graph” display mode.

The item set name is a name optionally determined by the user.

The item is information indicating the type of equipment information to be displayed by display device 200. For example, “Inside temperature setting” indicates the set value (target value) of a temperature in cooling equipment 310 (showcase), the value being set by cooling equipment 310. For example, “Inside temperature” indicates a temperature in cooling equipment 310, the temperature being measured by the sensor. Moreover, for example, “Evaporator inlet temperature” indicates a temperature of a refrigerant at the inlet of evaporator 336 that receives a flow of the refrigerant for cooling air drawn from the inlet. Furthermore, for example, “Evaporator outlet temperature” indicates a temperature of a refrigerant at the outlet of evaporator 336 that discharges the refrigerant. For example, “Thermostat” is information indicating the on/off of the supply of cold air into cooling equipment 310.

The information about the presence or absence of a default setting is information indicating the first combination of display modes and items according to the diagnosis result when the type of a malfunction is displayed by display device 200. For example, in the case of multiple combinations of display modes and items for the type of a malfunction, e.g., “Inside frost,” display control device 100 causes display device 200 to display the type of a malfunction with the combination having “Default” set (stored to be associated) with “circle.”

Subsequently, processing when warning data is obtained by display control device 100 (step 1: malfunctioning equipment registration) will be described below.

For example, when abnormal information is measured by the sensor, warning data indicating the occurrence of a malfunction is transmitted to display control device 100 by cooling system 300 (S103).

When receiving the warning data, display control device 100 identifies the type of a malfunction (diagnoses the cause of a malfunction), which has occurred in cooling system 300, based on the equipment information (more specifically, the setting information about a value set for equipment, such as cooling equipment 310, provided in cooling system 300 and the results of measurements by the sensors) (S104).

Display control device 100 may obtain the equipment information in advance from, for example, cooling system 300 with a predetermined period, obtain the equipment information with the warning data, or obtain the equipment information at any time.

The warning data includes, for example, information about equipment ID, information about a shop ID, information about the date of a malfunction, and information about the type of a warning about a high-temperature abnormality or the like.

Display control device 100 then registers, in an malfunctioning equipment list, information about the type of a malfunction that has occurred in cooling system 300 and IDs (equipment IDs) specific to cooling equipment 310 and 320 (S105). For example, display control device 100 stores the identified malfunction type that is associated with identifiers specific to cooling equipment 310 and 320, unique identifiers indicating the locations of cooling equipment 310 and 320, for example, a supermarket, and information about a date and time when the warning data is obtained.

FIG. 7 is a diagram illustrating a first example of a malfunctioning equipment list according to the embodiment.

The malfunctioning equipment list is information indicating equipment included in cooling system 300 which has transmitted the warning data and is judged as malfunctioning by cooling system 300, display control device 100, and the user.

The malfunctioning equipment list includes, for example, information about a equipment ID, information about a shop ID, information about the date of a malfunction, information about the type of a malfunction, information about a state of response, and information indicating stored figures (image data).

The equipment ID is an identifier specific to cooling equipment 310, 320, or the like. For example, display control device 100 may obtain the results of measurements by the sensors of cooling equipment 310 and 320 and the set value from cooling equipment 310 and 320, by communications with cooling equipment 310 and 320. In other words, display system 400 may include pieces of cooling equipment 310 and 320. The equipment ID is, for example, an identifier specific to each of cooling equipment 310 and 320.

The shop ID is an ID specific to a building, e.g., a supermarket where cooling system 300 is placed.

The information about the date of a malfunction is information indicating the date and time of a malfunction in cooling system 300. The information about the date of a malfunction may be information indicating a date and time when display control device 100 obtains the warning data, a date and time when cooling system 300 transmits the warning data, a date and time when cooling system 300 judges that a malfunction has occurred, and a date and time when sensor measurement results used for judging the occurrence of a malfunction by cooling system 300 are generated.

The information about the type of a malfunction is information indicating the type of a malfunction that has occurred in cooling system 300.

The information about the state of response is inputted by the user and indicates the contents of response from the user to cooling system 300.

The information about stored figures is image data on a display screen when display device 200 receives, from the user, an instruction to store the display screen on display device 200, the user having confirmed the equipment information displayed by display device 200.

Subsequently, processing for causing display device 200 to display the measurement information by display control device 100 (step 2: display processing) will be described below.

After step S105, display control device 100 transmits the malfunctioning equipment list to display device 200 (S106).

Step S106 may be performed only when information about the transmission of the malfunctioning equipment list to display device 200 is received from display device 200.

This allows display control device 100 to transmit the malfunctioning equipment list only upon a request from the user, thereby reducing the amount of communication and the processing load.

Display device 200 displays the received malfunctioning equipment list (S107).

For example, when display device 200 receives, from the user, an instruction to display detailed information including equipment information about a malfunction of cooling system 300, display device 200 transmits, to display control device 100, information about a request for detailed information about the malfunction of cooling system 300 (“Detail request” in FIG. 4).

When receiving the detail request, display control device 100 determines the display mode of the equipment information based on at least one of the type of the malfunction of cooling system 300 and the factor in identifying the type of the malfunction in step S104 (S109).

Display control device 100 then transmits the detailed information including information about the determined display mode, to display device 200 (S110).

For example, display control device 100 may generate image data on the display screen indicating the equipment information in the determined display mode, and transmit the generated image data as detailed information to display device 200. Alternatively, for example, display control device 100 may transmit, to display device 200, the detailed information including information about the determined display mode and the equipment information.

When receiving the detailed information, display device 200 displays the measurement information in the display mode determined by display control device 100, based on the received detailed information (S111).

Before receiving the detail request, display control device 100 may perform step S109 at any time after step S104.

When the identified malfunction type or the determined display mode is not included (not registered) in the display method list after step S109 is performed, the display method list may be updated by display control device 100 so as to further include the malfunction type and the display mode that are associated with each other.

### Processing by Display Control Device

Subsequently, processing performed by display control device 100 will be specifically described below.

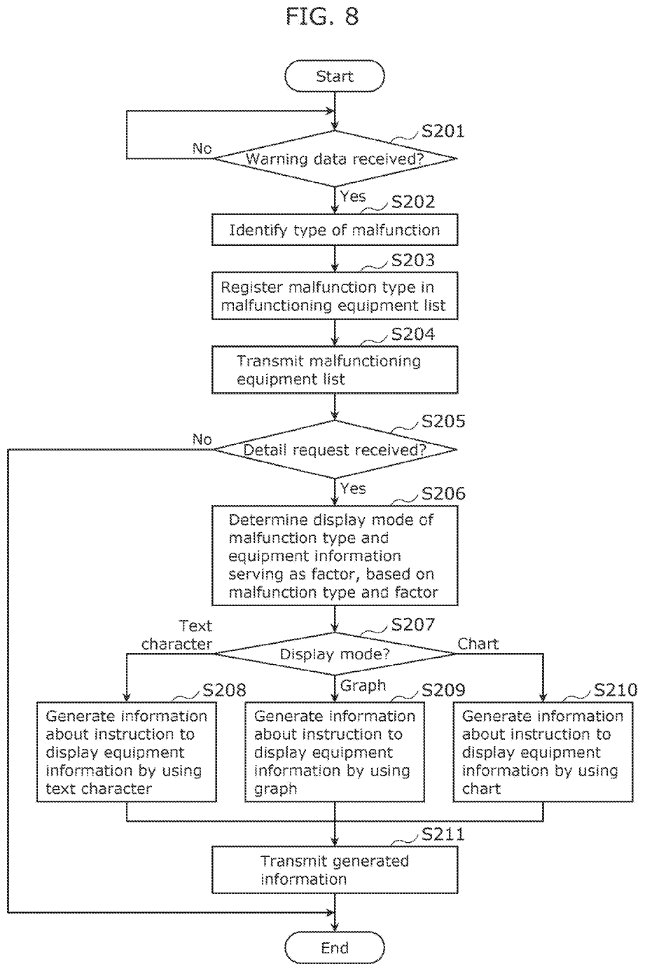

FIG. 8 is a flowchart indicating the processing steps of display control device 100 according to the embodiment.

First, judging unit 120 judges whether the warning data has been received or not (S201).

When it is judged that the warning data has not been received (No at S201), judging unit 120 continues the judgment in step S201.

When judging unit 120 judges that the warning data has been received (Yes at S201), identifying unit 130 identifies the type of a malfunction (diagnoses the cause of a malfunction) of cooling system 300 (S202). Display control device 100 may receive the measurement information (e.g., the measurement information and the information indicating the set value) of cooling system 300 in advance from cooling system 300 at any time. In the case of Yes at step S201, display control device 100 may obtain the measurement information from cooling system 300 by transmitting information for requesting the measurement information to cooling system 300. Alternatively, cooling system 300 may transmit the information along with the warning data. Obtaining unit 110 obtains the information received from cooling system 300 as described above. Identifying unit 130 identifies the type of a malfunction based on the information obtained by obtaining unit 110.

Subsequently, identifying unit 130 registers information about the identified malfunction type in the malfunctioning equipment list (S203).

Identifying unit 130 transmits the malfunctioning equipment list to display device 200 via communicating unit 160 (S204).

Subsequently, display control unit 150 judges whether the detail request has been received or not from display device 200, via communicating unit 160 (S205).

When display control unit 150 judges that the detail request has not been received (No at S205), the processing is terminated. For example, when the detail request has not been received upon the lapse of a predetermined time after step S204 is performed, display control unit 150 judges S205 to be No.

When it is judged that the detail request has been received (Yes at S205), display control unit 150 determines the display mode of the type of a malfunction and the equipment information used for identifying the malfunction by identifying unit 130, based on the type of the malfunction (diagnosis result) and a factor in identifying the type of the malfunction by identifying unit 130 (S206).

When the “character” display mode is determined in step S206 (“Character” at S207), display control unit 150 generates information about an instruction to display, by using text characters, the equipment information serving as the factor of identification by identifying unit 130 (S208). For example, display control unit 150 generates data on the display mode for indicating the equipment information by using text characters.

Display control device 100 may start processing from step S206 without performing steps S201 to S205.

In step S201, the process makes a transition to step S202 upon the reception of the warning data. The process is not limited thereto. For example, in step S201, display control device 100 may make a transition to S202 when receiving the equipment information from cooling system 300 and detecting a malfunction by using the function of detecting a malfunction from the equipment information. In this way, display control device 100 can detect a malfunction and inform the user of the occurrence of the malfunction in cooling system 300. Alternatively, instead of the detection of a malfunction by cooling system 300 in step S201, an operator may detect a malfunction via a telephone or a fax and start the process from step S202. This can respond to the detection of various anomalies.

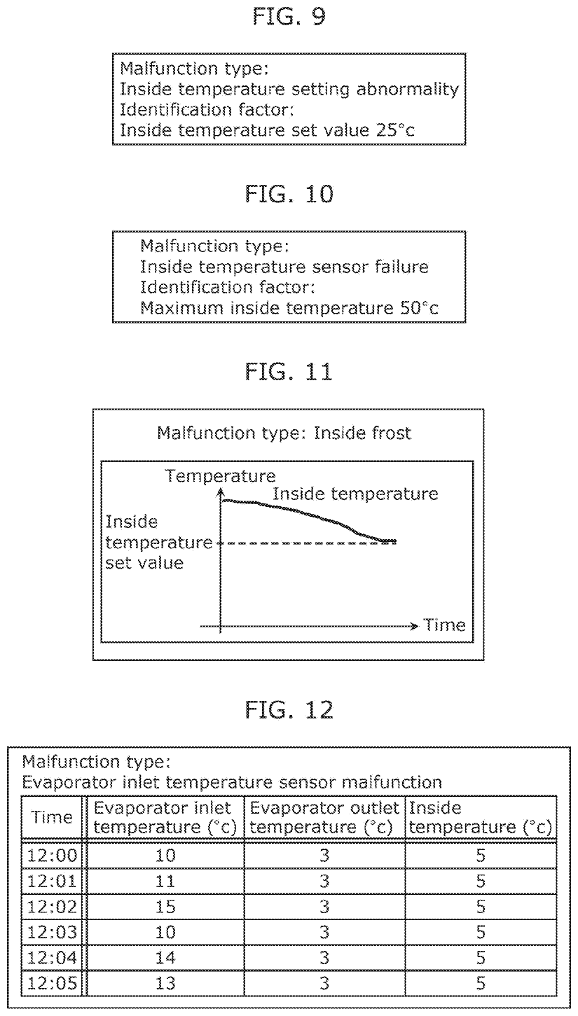

FIG. 9 is a diagram illustrating a first example of a display screen when equipment information is indicated using text characters on display device 200 according to the embodiment.

For example, it is assumed that identifying unit 130 identifies a set value abnormality as the type of a malfunction based on the setting information about the set value of an inside temperature. In this example, identifying unit 130 judges whether the set value of an inside temperature is greater than or equal to a threshold value. When the set value is judged as being greater than or equal to the threshold value, it is judged that an inappropriate value is set as the set value of an inside temperature. In this case, for example, determining unit 140 determines the character display mode because the type of a malfunction is a set value abnormality. In this case, as illustrated in FIG. 9, display control unit 150 causes display device 200 to display a display screen containing, for example, “Inside temperature setting abnormality” indicating the type of a malfunction (type information) and “Inside set temperature 25° C.” that indicates the setting information serving as a factor (identification factor) of identification by identifying unit 130 by using text characters.

FIG. 10 is a diagram illustrating a second example of a display screen when equipment information is indicated using text characters on display device 200 according to the embodiment.

For example, it is assumed that identifying unit 130 identifies a failure of the sensor for measuring an inside temperature, as the type of a malfunction based on the measurement information about the measurement result of an inside temperature. In this example, identifying unit 130 judges whether an inside temperature is greater than or equal to a threshold value. When the inside temperature is judged as being greater than or equal to the threshold value, it is judged that the malfunction type is a failure of the sensor for measuring an inside temperature. In this case, for example, determining unit 140 determines the character display mode because the type of a malfunction is a failure of the sensor for measuring an inside temperature and the factor is the measured value of the sensor for measuring an inside temperature. In this case, as illustrated in FIG. 10, display control unit 150 causes display device 200 to display a display screen containing, for example, “Inside temperature sensor failure” indicating the type of a malfunction and “Maximum inside temperature 50° C.” that indicates the equipment information serving as a factor of identification by identifying unit 130 by using text characters.

Alternatively, when the “graph” display mode is determined in step S206 (“Graph” at S207), display control unit 150 generates information about an instruction to display, by using a graph, the equipment information serving as the factor of identification by identifying unit 130 (S209). For example, display control unit 150 generates data on the display mode for indicating the equipment information by using a graph.

FIG. 11 is a diagram illustrating a first example of a display screen when equipment information is indicated using a graph on display device 200 according to the embodiment.

For example, it is assumed that identifying unit 130 identifies inside frost as the type of a malfunction based on items of measurement information (time series data) about the measurement results of an inside temperature. In this case, for example, determining unit 140 determines the graph display mode because of the time series data. In this case, as illustrated in FIG. 11, display control unit 150 causes display device 200 to display a display screen containing, for example, “Inside frost” indicating the type of a malfunction and a graph that indicates the equipment information (in this example, time series data about an inside temperature relative to a time) serving as a factor of identification by identifying unit 130.

Alternatively, when the “chart” display mode is determined in step S206 (“Chart” at S207), display control unit 150 generates information about an instruction to display, by using a chart, the equipment information serving as the factor of identification by identifying unit 130 (S210). For example, display control unit 150 generates data on the display mode for indicating the equipment information by using a chart.

FIG. 12 is a diagram illustrating a first example of a display screen when equipment information is indicated using a chart on display device 200 according to the embodiment.

For example, it is assumed that identifying unit 130 identifies a failure of the sensor for measuring an evaporator inlet temperature, as the type of a malfunction based on measurement information about the measurement result of an inside temperature, measurement temperature about the measurement result of an evaporator inlet temperature, and measurement information about the measurement result of an evaporator outlet temperature. In this example, identifying unit 130 judges that the malfunction type is a failure of the sensor for measuring an evaporator inlet temperature when an inside temperature and an evaporator outlet temperature are judged as being normal (for example, within a predetermined temperature range) and an evaporator inlet temperature is judged as being abnormal (for example, greater than or equal to a threshold value). In this case, for example, determining unit 140 determines the chart display mode because the type of a malfunction is a failure of the sensor for measuring an evaporator inlet temperature and the factor is based on the results of measurements by the sensors. In this case, as illustrated in FIG. 12, display control unit 150 causes display device 200 to display a display screen containing, for example, “Evaporator-inlet-temperature sensor malfunction” indicating the type of a malfunction and a chart that indicates the equipment information (in this example, a chart indicating an evaporator inlet temperature, an evaporator outlet temperature, an inside temperature, and the measurement times thereof) serving as a factor of identification by identifying unit 130.

After step S208, step S209, or step S210, display control device 100 transmits the generated information to display device 200 (S211).

Display control device 100 may skip step S204 and step S205 after step S203, and then perform step S204 and step S211 after performing steps S206 to S210.

Display control unit 150 may generate image data on text characters, a chart, or a graph in steps S208 to S210, and transmit the generated image data to display device 200 in step S211. Thus, display control unit 150 may cause display device 200 to display the equipment information in the determined display mode.

### Processing by Display Device

Subsequently, processing performed by display device 200 will be specifically described below.

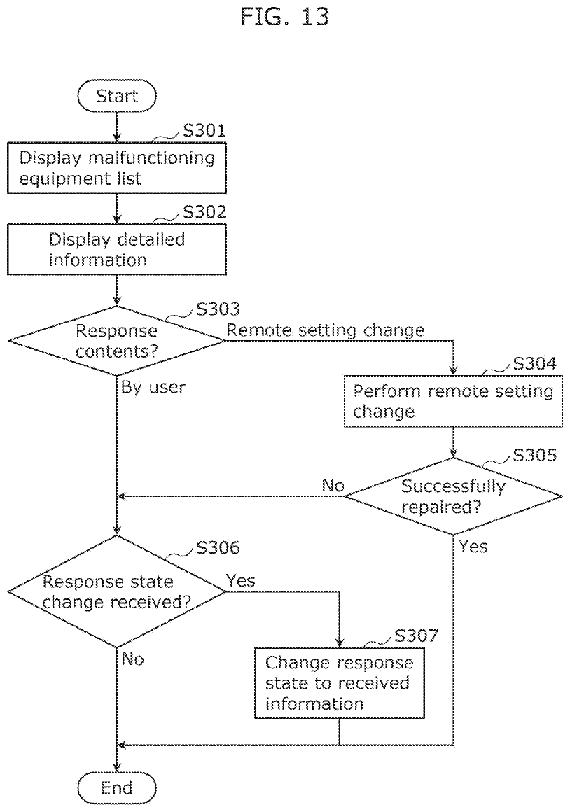

FIG. 13 is a flowchart indicating the processing steps of display device 200 according to the embodiment. Moreover, FIG. 13 is a flowchart indicating processing performed by display device 200 after processing in step S106 of FIG. 4 is performed.

First, control unit 230 causes display unit 210 to display the malfunctioning equipment list received from display control device 100 (S301).

It is assumed that receiving unit 220 then receives, from the user, an instruction to display the detailed information. In this case, control unit 230 transmits a detail request to display control device 100.

When receiving the detailed information from display control device 100, control unit 230 causes display unit 210 to display the detailed information (S302).

Thereafter, the user examines, for example, a response to cooling equipment (hereinafter referred to as cooling equipment 310) with a state of response of “Not yet” (S303).

For example, when receiving unit 220 receives an instruction to change the set value of cooling equipment 310 (“Remote setting change” at S303), control unit 230 changes a remote setting (S304). In the remote setting change, for example, control unit 230 transmits, to display control device 100, information indicating the set value received by receiving unit 220, display control device 100 transmits the information to cooling equipment 310, and cooling equipment 310 changes the set value based on the information.

Control unit 230 then judges whether the malfunction of cooling equipment 310 has been corrected or not (whether cooling equipment 310 has been successfully repaired or not) (S305). For example, control unit 230 may judge that the malfunction of cooling equipment 310 has been corrected when receiving information about the correction of the malfunction from cooling equipment 310 via display control device 100 or judge that the malfunction of cooling equipment 310 has been corrected when receiving unit 220 receives information about the correction of the malfunction.

Step S305 may be performed by display control device 100. For example, when obtaining the information about the set value, display control device 100 transmits the information to cooling equipment 310, causing cooling equipment 310 to change the set value. Furthermore, display control device 100 may obtain information about a current set value from, for example, cooling equipment 310 thereafter. Whether the malfunction of cooling equipment 310 has been corrected or not may be judged based on the information.

When it is judged that the malfunction of cooling equipment 310 has been corrected (Yes at S305), control unit 230 terminates the processing.

For example, when receiving unit 220 does not receive an instruction to change the set value of cooling equipment 310 in step S303 (“By user” at S303) or when it is judged that the malfunction of cooling equipment 310 has not been corrected (No at S305), control unit 230 judges whether the change of the state of response to cooling equipment 310 has been received or not (S306).

When it is judged that the change of the state of response to cooling equipment 310 has been received (Yes at S306), control unit 230 changes information about “State of response” in the malfunctioning equipment list to the received information (S307).

When receiving an instruction to change a state of response of “Not yet” in step S306 to “Repair date under adjustment” (Yes at S306), control unit 230 changes the state of response in the malfunctioning equipment list to “Repair date under adjustment.”

Control unit 230 may transmit the received information or the changed malfunctioning equipment list to display control device 100.

When it is judged that the change of the state of response to cooling equipment 310 has not been received (No at S306), control unit 230 terminates the processing.

Steps S303 to S305 need not be performed. In this case, for example, display control device 100 judges whether a malfunction that has occurred in cooling equipment 310 can be corrected or not, based on the type of a malfunction. When display control device 100 judges that the malfunction that has occurred in cooling equipment 310 can be corrected, the malfunction that has occurred in cooling equipment 310 may be corrected by, for example, changing the set value of cooling equipment 310 in response to an instruction to change the set value through communications with cooling equipment 310.

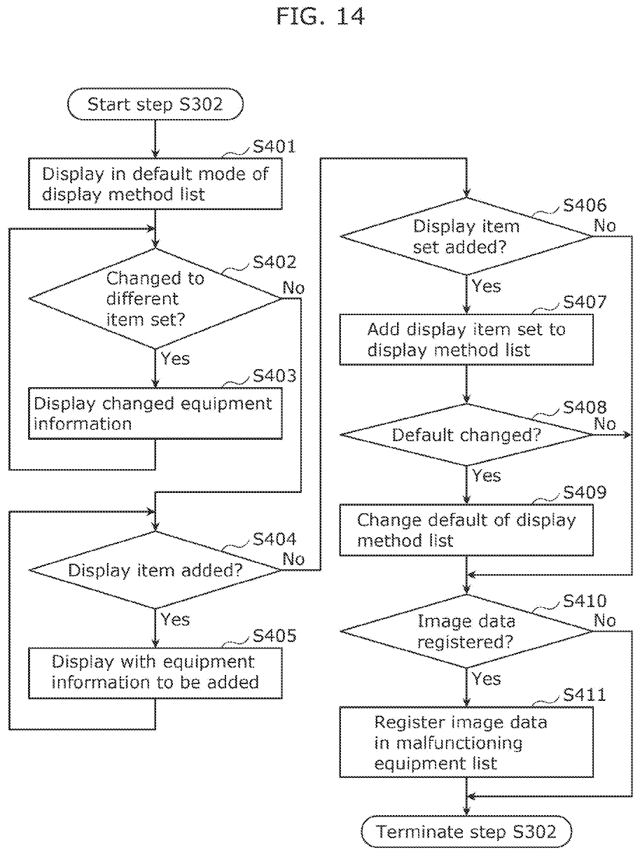

FIG. 14 is a flowchart indicating the details of display processing (step S302) of the detailed information performed by display device 200 according to the embodiment.

First, control unit 230 causes display unit 210 to display the equipment information in the default display mode set in the display method list (S401).

Control unit 230 then judges whether an instruction has been received by receiving unit 220 that causes display unit 210 to display the equipment information in the display mode based on an item set different from a current item set (S402). In other words, control unit 230 judges whether receiving unit 220 has received an instruction to change the equipment information to be displayed by display unit 210.

When it is judged that receiving unit 220 has received an instruction to change the equipment information to be displayed by display unit 210 (Yes at S402), control unit 230 changes, based on the instruction received by receiving unit 220, the equipment information to be displayed by display unit 210, and causes display unit 210 to display the changed equipment information (S403).

When it is judged that receiving unit 220 has not received an instruction to change the equipment information to be displayed by display unit 210 (No at S402), control unit 230 judges whether receiving unit 220 has received an instruction to add a display item of the equipment information displayed by display unit 210 (S404).

When it is judged that receiving unit 220 has received the instruction to add a display item of the equipment information displayed by display unit 210 (Yes at S404), control unit 230 causes display unit 210 to display the equipment information to be added (S405).

When it is judged that receiving unit 220 has not received the instruction to add a display item of the equipment information displayed by display unit 210 (No at S404), control unit 230 judges whether an instruction to add the current display item set to the display method list has been received or not (S406).

When it is judged that the instruction to add the current display item set to the display method list has been received (Yes at S406), control unit 230 adds the current display item set to the display method list (S407).

Subsequently, control unit 230 judges whether receiving unit 220 has received an instruction to change a default set in the display item set (S408).

When it is judged that receiving unit 220 has received the instruction to change the default set in the display item set (Yes at S408), control unit 230 changes the default of the display item set in the display method list based on the received instruction (S409).

When it is judged that (i) subsequent to step S409, (ii) receiving unit 220 has not received the instruction to change the default set in the display item set (No at S408) or (iii) receiving unit 220 has not received the instruction to add the current display item set to the display method list (No at S406), control unit 230 judges whether receiving unit 220 has received an instruction to register, in the malfunctioning equipment list, data (image data) on a display screen currently displayed by display unit 210 (S410).

When it is judged that receiving unit 220 has received the instruction to register the image data (Yes at S410), control unit 230 registers the image data in the malfunctioning equipment list (S411) and terminates the processing.

When it is judged that receiving unit 220 has not received the instruction to register the image data (No at S410), control unit 230 terminates the processing without registering, as image data, the display screen currently displayed by display unit 210.

In the display mode (e.g., a chart or character display mode) that increases a data amount by forming an image, step S410 and step S411 may be skipped. This can reduce the amount of a user operation.

Control unit 230 may transmit the display method list and/or malfunctioning equipment list to display control device 100 after making the change and/or addition in steps S401 to S411. Thus, also in display control device 100, information about the display method list and/or malfunctioning equipment list can be properly updated.

Step S406 need not be always performed or may be performed only when the user is authorized to act as an administrator.

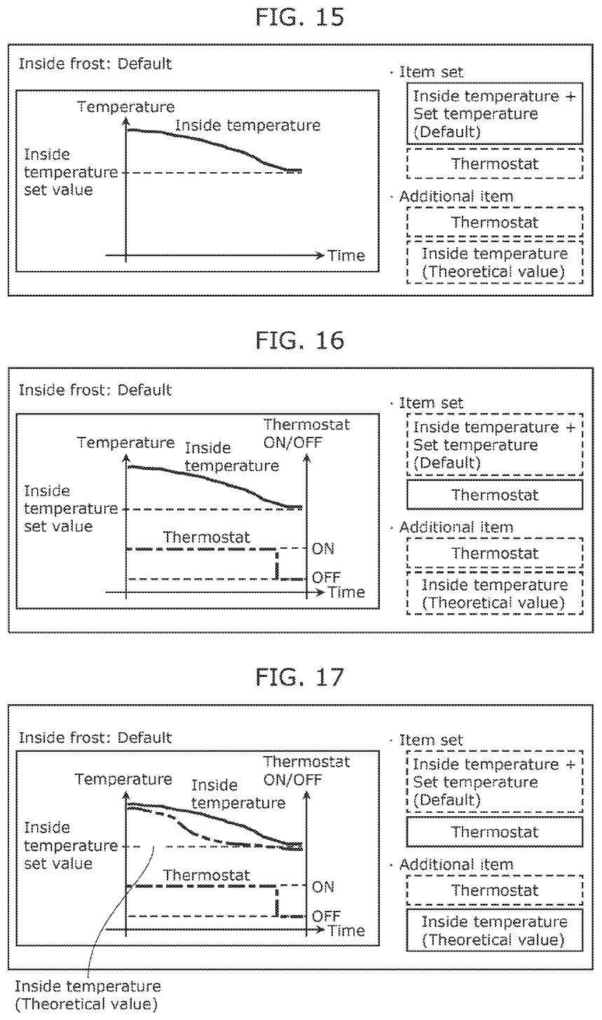

FIG. 15 is a diagram illustrating a second example of a display screen when equipment information is indicated using a graph on display device 200 according to the embodiment.

For example, in step S401, as in the display method list in FIG. 6, control unit 230 causes display unit 210 to display the equipment information (“Inside temperature” and “Inside-temperature set value” in FIG. 6) about the display item set (“Item” in FIG. 6), which is set as a default, in the set display mode (“Graph” of “Display” in FIG. 6) when the type of a malfunction is inside frost. In this case, for example, control unit 230 causes display unit 210 to display the display screen as illustrated in FIG. 15. The example of FIG. 15 indicates the equipment information when the display item set is “Inside temperature+Set temperature (default).”

FIG. 16 is a diagram illustrating a third example of a display screen when equipment information is indicated using a graph on display device 200 according to the embodiment.

For example, when it is judged that receiving unit 220 has received an instruction to change, from “Inside temperature +Set temperature (default)” to “Thermostat” in the display item set, the equipment information to be displayed by display unit 210 (for example, Yes at step S402), control unit 230 causes display unit 210 to display a display screen (graph) as indicated in FIG. 16, in which “Thermostat” of the measurement information is added to the graph of FIG. 15.

FIG. 17 is a diagram illustrating a fourth example of a display screen when equipment information is indicated using a graph on display device 200 according to the embodiment.

For example, when it is judged that receiving unit 220 has received an instruction to add “Inside temperature (theoretical value)” of the equipment information displayed by display unit 210 (for example, Yes at step S404), control unit 230 causes display unit 210 to display a display screen (graph) as indicated in FIG. 17, in which “Inside temperature (theoretical value)” as an additional item is added to the graph of FIG. 16.

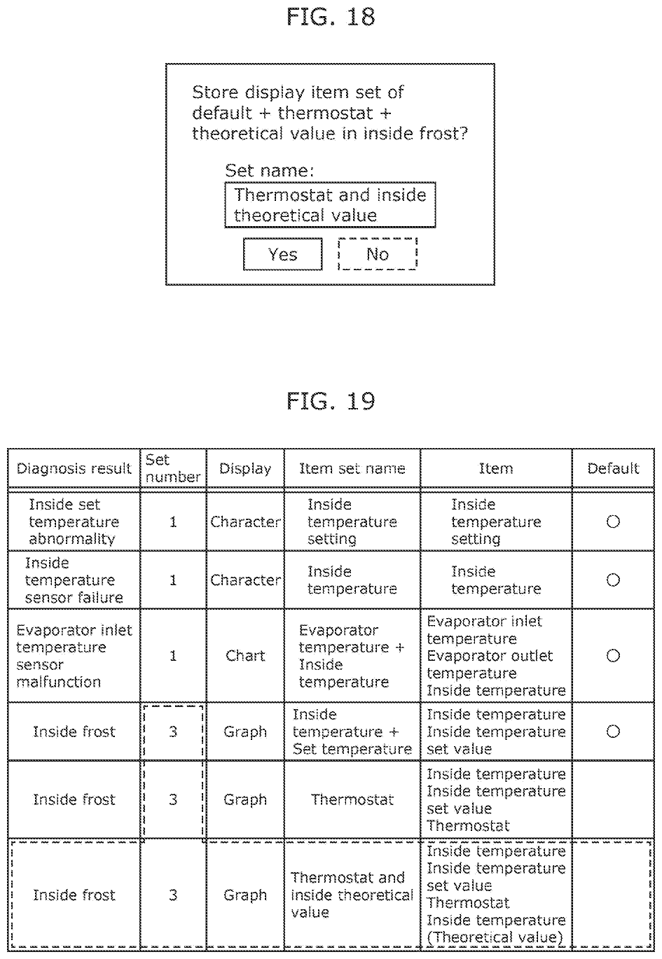

FIG. 18 is a diagram illustrating an example of a display screen that is displayed when display device 200 according to the embodiment receives an instruction to add a display item set.

For example, in step S406, control unit 230 causes display unit 210 to display a display screen for receiving an instruction to add a current display item set, for example, “Store display item set of default +thermostat +theoretical value in inside frost?” to the display method list from the user as indicated in FIG. 18. For example, control unit 230 judges “Yes” at step S406 when the input of a set name is received and “Yes” is tapped on a touch panel display (display unit 210 and receiving unit 220 that are provided for display device 200) for displaying the display screen of FIG. 18.

FIG. 19 is a diagram illustrating a second example of a display method list according to the embodiment.

For example, when the input of the set name (e.g., “Thermostat and inside theoretical value”) is received in step S406 and “Yes” is tapped on the touch panel display for displaying the display screen of FIG. 18, control unit 230 stores the received input of the set name (“Item set name” in FIG. 19) and an item, that is, control unit 230 adds the set name and the item to the display method list such that the set name and the item are associated with each other. This processing increases the number of sets of “Inside frost”, the type of a malfunction, causing control unit 230 to change the number of sets to three.

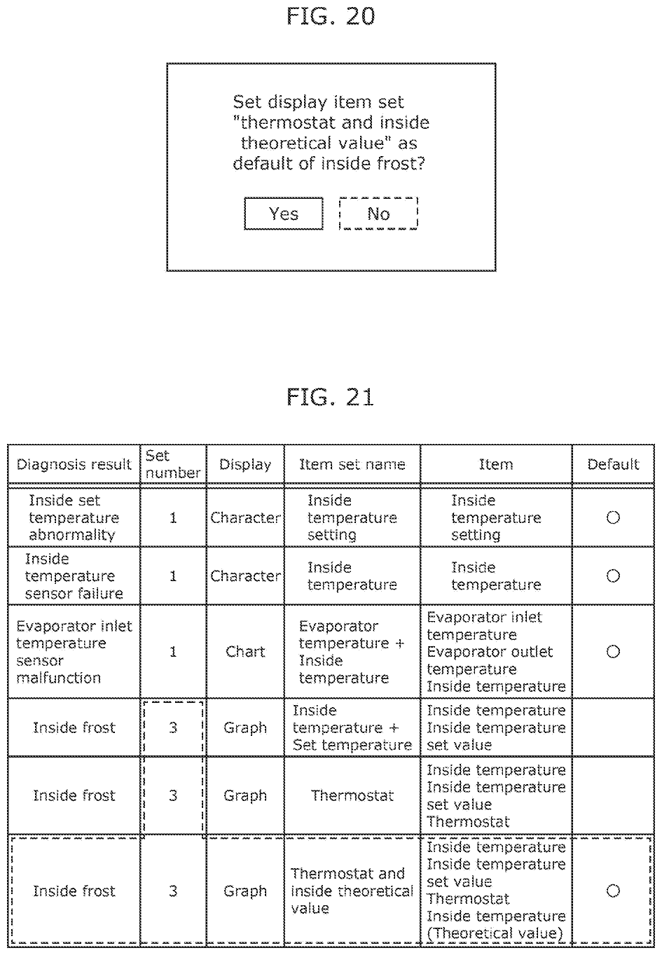

FIG. 20 is a diagram illustrating an example of a display screen to be displayed when display device 200 according to the embodiment receives a change of a first display screen (i.e., a default) to be displayed according to the type of a malfunction (diagnosis result).

For example, in step S408, control unit 230 causes display unit 210 to display a display screen for receiving an instruction to change a default, for example, “Set display item set “Thermostat and inside theoretical value” as default of inside frost?” that is set in the display item set from the user as indicated in FIG. 20. For example, control unit 230 judges “Yes” at step S408 when “Yes” is tapped on a touch panel display for displaying the display screen of FIG. 20.

FIG. 21 is a diagram illustrating a third example of a display method list according to the embodiment.

For example, control unit 230 judges “Yes” at step S408 and changes the default setting to “Thermostat and inside theoretical value” of the item set name as indicated in FIG. 21 when “Yes” is tapped on the touch panel display for displaying the display screen of FIG. 20. Thus, for example, when the measurement information about a malfunction is displayed again and the type of the malfunction is inside frost, control unit 230 causes display unit 210 to first display an inside temperature, an inside temperature set value, a thermostat, and an inside temperature (theoretical value), which are items associated with “Thermostat and inside theoretical value” in the default item set name, in the graph display mode.

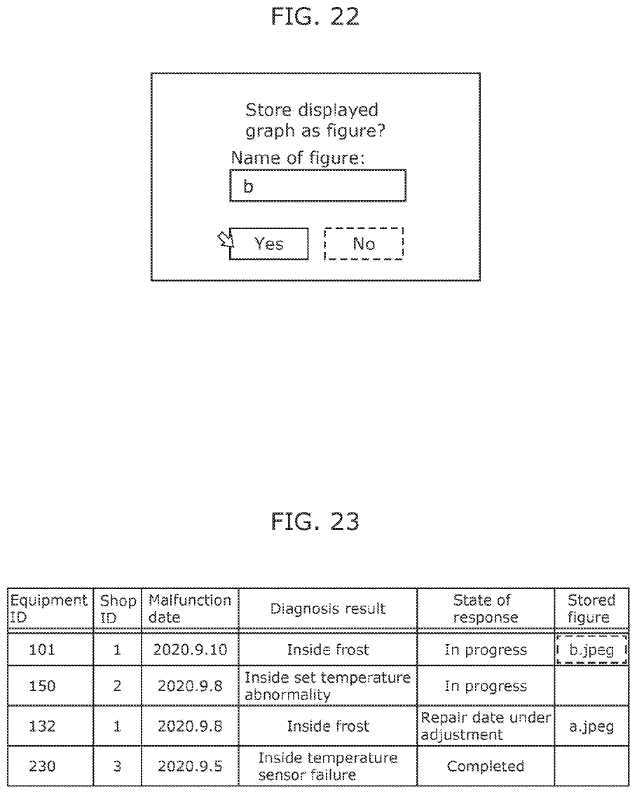

FIG. 22 is a diagram illustrating an example of a display screen to be displayed upon receipt of the registration of image data on the display screen displayed by display device 200 according to the embodiment.

For example, in step S410, control unit 230 causes display unit 210 to display the display screen for receiving, from the user, an instruction to register image data on the display screen indicating the equipment information displayed by display unit 210, for example, “Store displayed graph as figure?” as indicated in FIG. 22. For example, control unit 230 judges “Yes” at step S410 when the input of an image data name is received (“b” in FIG. 22) and

“Yes” is tapped on a touch panel display for displaying the display screen of FIG. 22.

FIG. 23 is a diagram illustrating a second example of a malfunctioning equipment list according to the embodiment.

For example, control unit 230 judges “Yes” at step S410 when “Yes” is tapped on the touch panel display for displaying the display screen of FIG. 22, and as indicated in FIG. 23, control unit 230 registers image data (image file) with a file name (“b” in this example)+extension (“jpeg” in this example) in “Stored figure” of the malfunctioning equipment list. In other words, control unit 230 stores the image data associated with, for example, a equipment ID and a shop ID that correspond to the image data.

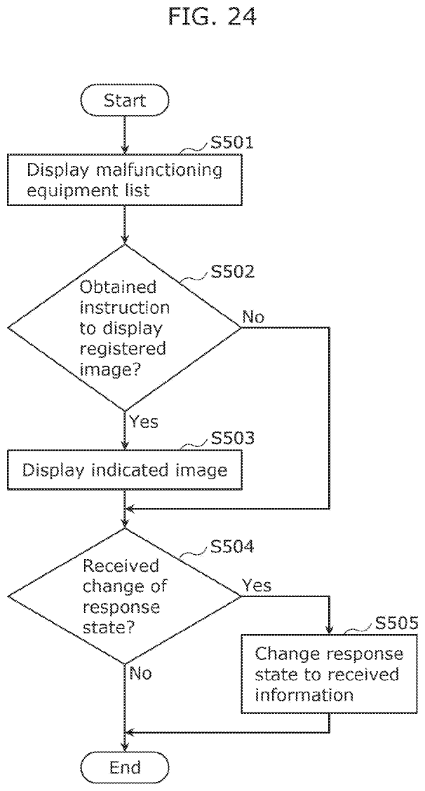

FIG. 24 is a flowchart indicating the details of display processing of registered image data (image) performed by display device 200 according to the embodiment. FIG. 24 indicates, for example, processing performed by display device 200 after processing in FIG. 14 is performed by display device 200.

For example, first, when receiving unit 220 receives an instruction to display the malfunctioning equipment list, control unit 230 causes display unit 210 to display the malfunctioning equipment list (S501).

Subsequently, control unit 230 judges whether receiving unit 220 has received an instruction to display a registered image (S502).

When it is judged that receiving unit 220 has received the instruction to display a registered image (Yes at S502), control unit 230 causes display unit 210 to display the indicated image (S503).

For example, it is assumed that control unit 230 causes display unit 210 to display the malfunctioning equipment list in FIG. 23 in step S501 and “b.jpeg” on the touch panel display for displaying the malfunctioning equipment list is tapped in step S502. In this case, for example, control unit 230 causes display unit 210 to display the image of “b.jpeg” (e.g., the display screen of FIG. 17) in step S503.

For example, before repairing cooling equipment 310 which is malfunctioning, the user causes display device 200 to perform the processing of FIG. 14. When cooling equipment 310 which is malfunctioning is repaired, the user causes display device 200 to perform the processing of steps S501 to S503 in FIG. 24.

For example, in the case of on-site service for cooling equipment 310 by the user, the user causes display device 200 to perform the processing of FIG. 14 before a business trip. Thus, only by performing the processing in FIG. 24 by means of display device 200 during the on-site service, display device 200 can quickly display an image requested by the user.

Subsequent to step S503 or when it is judged that receiving unit 220 has not received an instruction to display the registered image (No at S502), control unit 230 judges whether a change of the state of response in the malfunctioning equipment list has been received or not (S504).

When it is judged that the change of the state of response has been received (Yes at S504), control unit 230 changes the state of response to the received information (S505).

For example, when the repair of cooling equipment 310 is completed, the user operates display device 200 to change the state of response to equipment ID 101 in FIG. 23 from “In progress” to “Completed.”

Subsequent to step S505 or when it is judged that the change of the state of response has not been received (No at S504), control unit 230 terminates the processing.

### SPECIFIC EXAMPLES

Subsequently, a specific example of the display mode of the equipment information displayed by display device 200 will be described below. The specific examples of the display mode of the equipment information displayed by display device 200 were described with reference to FIGS. 9 to 12. The type of a malfunction that determines the display mode and the factor (identification factor) for identifying the type of a malfunction are not limited thereto.

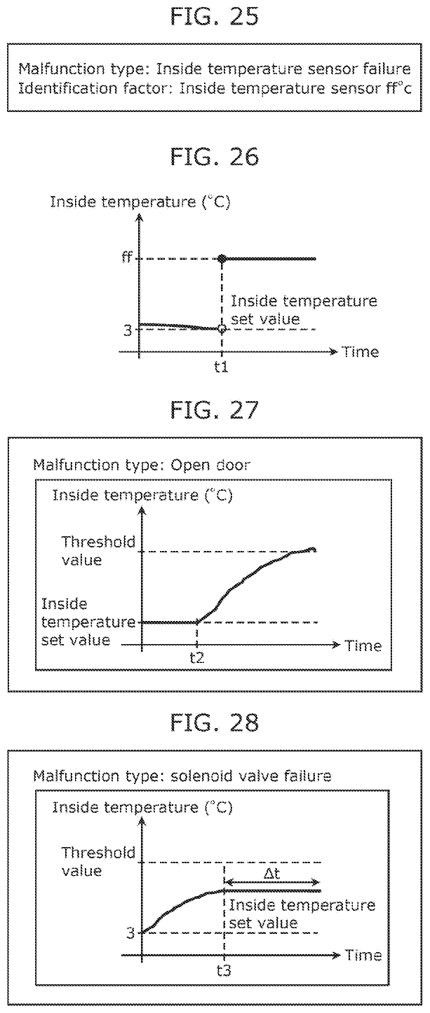

FIG. 25 is a diagram illustrating a third example of a display screen when equipment information is indicated using text characters on display device 200 according to the embodiment. FIG. 26 is a diagram illustrating an example of a measurement result of a sensor when equipment information is displayed using text characters on display device 200 according to the embodiment.

For example, as indicated by the graph of FIG. 26, it is assumed that an inside temperature rapidly changes from 3° C. to ff° C. at time t1. In this way, for example, when it is judged that a change of an inside temperature per unit time is greater than or equal to a threshold value, identifying unit 130 identifies a failure of inside temperature sensor 332 as the type of a malfunction. In this case, for example, determining unit 140 determines the character display mode for displaying an inside temperature (ff° C.) by display device 200 because the type of a malfunction is a failure of inside temperature sensor 332. The inside temperature is a measurement result serving as a factor in identifying the malfunction by identifying unit 130. In this case, for example, display control unit 150 causes display device 200 to display a display screen containing “Inside temperature sensor failure” indicating the type of a malfunction and “Inside temperature sensor ff° C.” that indicates the identification factor by using text characters.

FIG. 27 is a diagram illustrating a fifth example of a display screen when equipment information is indicated using a graph on display device 200 according to the embodiment. For example, as indicated by the graph of FIG. 27, it is assumed that an inside temperature gradually rises from time t2. For example, the example in FIG. 27 is a graph that can be confirmed when a door provided for cooling equipment 310 is opened at time t2 and the opened state continues. The door is provided to open and close an opening connecting the inside and the outside of the equipment. In this case, cooling equipment 310 output the warning data when the inside temperature exceeds a threshold value. For example, when it is judged that an inside temperature kept at an inside temperature set value until time t2 rises with a change less than or equal to a predetermined value per unit time such that the change increases from time t2 and exceeds a threshold value, identifying unit 130 identifies “Open door,” which indicates an opened state of the door of cooling equipment 310, as the type of a malfunction. In this case, for example, determining unit 140 causes display device 200 to display a display screen containing “Open door” indicating the type of a malfunction and a change of the inside temperature over time (time series data), the change indicating the identification factor as a graph. This is because the identification factor is that a change less than or equal to the predetermined value per unit time exceeds the threshold value.

FIG. 28 is a diagram illustrating a sixth example of a display screen when equipment information is indicated using a graph on display device 200 according to the embodiment.

For example, as indicated by the graph of FIG. 28, it is assumed that an inside temperature gradually rises from the inside temperature set value until time t3 and is kept between a threshold value and the inside temperature set value. For example, the example of FIG. 28 is a graph that can be confirmed when only part of a refrigerant necessary for cooling the inside of cooling equipment 310 flows into cooling equipment 310. For example, when it is judged that the inside temperature is kept between the inside temperature set value and the threshold value inclusive for a predetermined period Δt, identifying unit 130 identifies a failure of a solenoid valve as the type of a malfunction. In this case, for example, determining unit 140 causes display device 200 to display a display screen containing “Solenoid valve failure” indicating the type of a malfunction and a change of the inside temperature over time (time series data), the change indicating the identification factor as a graph. This is because the identification factor is that the inside temperature is judged as a temperature kept between the inside temperature set value and the threshold value inclusive for the predetermined period Δt.

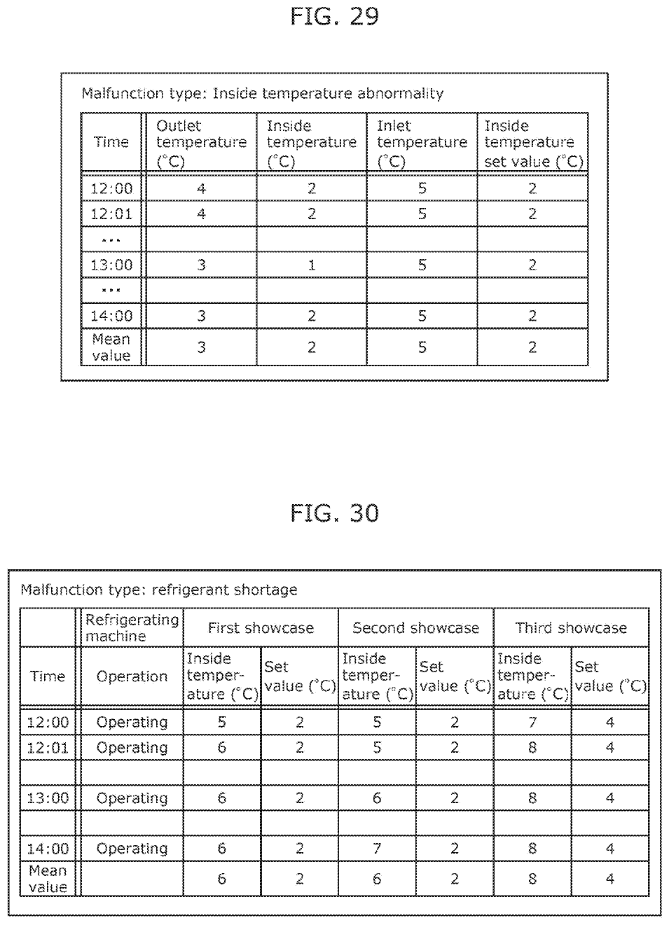

FIG. 29 is a diagram illustrating a second example of a display screen when equipment information is indicated using a chart on display device 200 according to the embodiment.

For example, as indicated by the chart of FIG. 29, it is assumed that an inlet temperature>an outlet temperature>an inside temperature is determined at a predetermined time (at each time in the present example). Typically, an inlet temperature>an inside temperature>an outlet temperature is determined when cooling equipment 310 operates without any anomalies. In this way, for example, when it is judged that an inlet temperature>an outlet temperature>an inside temperature is determined at the predetermined time, identifying unit 130 identifies “Inside temperature abnormality,” which indicates a state in which a malfunction regarding the inside temperature has occurred, as the type of malfunction. In this case, for example, determining unit 140 causes display device 200 to display a display screen containing “Inside temperature abnormality” indicating the type of a malfunction and a chart of the measurement results of inlet temperature sensor 333, inside temperature sensor 332, and outlet temperature sensor 331, the measurement results serving as the identification factor. This is because the identification factor is based on the measurement results obtained from the different sensors at the predetermined time, like an inlet temperature>an outlet temperature>an inside temperature.

FIG. 30 is a diagram illustrating a third example of a display screen when equipment information is indicated using a chart on display device 200 according to the embodiment.

Display system 400 for obtaining measurement results in FIG. 30 is, for example, a system for supplying cold air from single refrigerating machine 324 to three showcases 321, 322, and 323 as illustrated in FIG. 1.

For example, as indicated by the chart of FIG. 30, it is assumed that inside temperatures in a first showcase, a second showcase, and a third showcase are different from the set value (inside set temperature) even though the refrigerating machines are being operated in all the showcases, that is, cold air is supplied from the refrigerating machines to the showcases at the predetermined time (in the present example, at each time). In this way, for example, when inside temperatures similarly fail to reach the inside set temperature in the showcases, identifying unit 130 identifies “Refrigerant shortage,” which indicates a shortage of a refrigerant in the refrigerating machine. In this case, for example, determining unit 140 causes display device 200 to display a display screen containing “Refrigerant shortage” indicating the type of a malfunction and a chart of the measurement results of the sensors for measuring inside temperatures in the showcases, the measurement results serving as the identification factor. This is because the identification factor is based on the measurement results obtained from the same type of sensors (in the present example, the sensors for measuring inside temperatures) in the different showcases at the predetermined time such that inside temperatures similarly fail to reach the inside set temperature in the showcases.

### SUMMARY

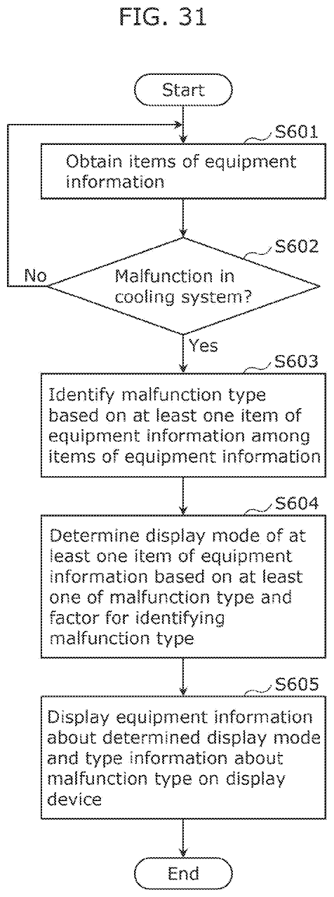

Display control device 100 described above performs the processing of FIG. 31.

FIG. 31 is a flowchart indicating the processing steps of the display control method according to the embodiment.

First, obtaining unit 110 obtains items of equipment information about cooling system 300 from cooling system 300 (S601).

Judging unit 120 then judges whether a malfunction has occurred in cooling system 300 (S602). For example, judging unit 120 judges whether a malfunction has occurred in cooling system 300, depending upon whether the warning data has been obtained or not.

When judging unit 120 judges that a malfunction has not occurred in cooling system 300 (No at S602), display control device 100 returns the processing to step S601.

When judging unit 120 judges that a malfunction has occurred in cooling system 300 (Yes at S602), identifying unit 130 identifies the type of the malfunction having occurred in cooling system 300, based on at least one of the items of the equipment information obtained from cooling system 300 (S603).

Determining unit 140 then determines the display mode of the at least one item of the equipment information based on at least one of the type of the malfunction that has occurred in cooling system 300 and a factor for identifying the type of the malfunction by identifying unit 130 (S604).

Subsequently, display control unit 150 causes display device 200 to display the at least one item of the equipment information of the display mode determined by determining unit 140 and the type information indicating the type of the malfunction (step S605).

### Effects, Etc.

As described above, the display control method according to the present disclosure includes: judging (S602) whether a malfunction has occurred in a cooling system including a plurality of sensors (for example, the sensors included in cooling-equipment sensor unit 312 and the sensors included in sensor terminal 330) and cooling equipment (for example, cooling equipment 310 and cooling equipment 320); when it is judged in the judging that a malfunction has occurred in cooling system 300, identifying (S603) a type of the malfunction based on at least one item of equipment information among items of equipment information obtained from cooling system 300 and including at least one of measurement information indicating measurement results of the plurality of sensors or setting information regarding cooling system 300; determining (S604) a display mode for the at least one item of equipment information based on at least one of the type of the malfunction or a factor in identifying the type of the malfunction; and causing (S605) display device 200 to display (i) the at least one item of equipment information in the display mode determined in the determining and (ii) type information indicating the type of the malfunction.

Conventionally, in the event that a malfunction has occurred in a piece of equipment, a system identifies the type of the malfunction and displays the identified malfunction type of the equipment and the factor (data) of the occurrence of the malfunction. This allows the user to confirm the malfunction type identified by the system. The user can also confirm displayed data and thus the type of a malfunction that has occurred in equipment can be identified by the user. Conventionally, in such a display device, data to be displayed is determined based on, for example, a time when abnormal data is measured. However, some malfunction types can be identified from a small amount of data by the user. In this case, when the same amount of data is displayed as in the identification of the type of a malfunction from many pieces of data, the user requires a long time to identify the type of a malfunction. In the display control method according to the present disclosure, the equipment information can be displayed by display device 200 in the display mode based on at least one of the type of a malfunction and a factor in identifying the type of the malfunction, the equipment information being regarded as being necessary for the user to identify the type of the malfunction that has occurred in cooling system 300. Thus, appropriate data (measurement information) regarded as being necessary for the user to identify the type of the malfunction can be displayed by display device 200 in an appropriate display mode, so that the data can be displayed in an easier way for the user to understand than in the related art. The user can speed up an operation for identifying the type of a malfunction. The data is displayed by display device 200 in the display mode based on at least one of the type of a malfunction and a factor in identifying the type of the malfunction, thereby eliminating the need for processing for displaying data assumed to be unnecessary. This can reduce a throughput and speed up processing for displaying data.

Furthermore, for example, in the determining, the display mode is determined based on the type of the malfunction.

For example, when the type of a malfunction is a set value abnormality, the user can surely identify the type of the malfunction according to the set value. When a high temperature is measured by a temperature sensor among the sensors provided for cooling system 300, a temperature abnormality is identified as the type of a malfunction. In this case, it may be difficult to determine whether the cooling equipment has an abnormal temperature or the temperature sensor has failed. In such a case, a graph of the time series data of the temperature sensor facilitates the identification of the type of a malfunction by the user. This can determine an appropriate display mode with simple processing.

Furthermore, for example, in the determining, the display mode is determined based on the factor.

For example, when the type of a malfunction is a sensor malfunction and is identified by a rapid change of the measured temperature of the sensor, the user can identify the type of the malfunction by using data around the time of the change. When the type of a malfunction is identified by comparing the measurement results of the sensors, the measurement results of the sensors are necessary for the user to identify the type of the malfunction. Thus, a more appropriate display mode can be determined based on a factor in identifying the malfunction.

Furthermore, for example, the items of equipment information include measurement results. In this case, for example, in the identifying, the type of the malfunction is identified based on at least one measurement result among the measurement results of measurements by each of the plurality of sensors.

This can determine an appropriate display mode based on the measurement results of the sensors.

Furthermore, for example, in the determining, when the factor in identifying the type of the malfunction is that the at least one measurement result is greater than or equal to a first threshold value, the display mode is determined such that each of (i) a type of a sensor that generated the at least one measurement result and (ii) a largest value among the at least one measurement result which is greater than or equal to the first threshold value is indicated using text characters, the sensor being included in the plurality of sensors.

Furthermore, for example, in the determining, when the factor in identifying the type of the malfunction is that the at least one measurement result is less than or equal to a second threshold value, the display mode is determined such that each of (i) a type of a sensor that generated the at least one measurement result and (ii) a smallest value among the at least one measurement result which is less than or equal to the second threshold value is indicated using text characters, the sensor being included in the plurality of sensors.

When the factor in identifying the type the malfunction is the one measurement result, the user can easily identify the type of the malfunction even in the character display mode because of the small amount of information. However, the display of unnecessary data in a graph or a chart makes it difficult for the user to identify the type of a malfunction. Thus, data can be displayed in an easy way for the user to understand.

Furthermore, for example, in the determining, when the factor in identifying the type of the malfunction is that a value which is a measurement result of measurement by a first sensor among the plurality of sensors does not reach a third threshold value within a first predetermined period, the display mode is determined such that (i) each of values of measurement results of measurements by the first sensor within the first predetermined period and (ii) the third threshold value are indicated using a graph.

Furthermore, for example, in the determining, when the factor in identifying the type of the malfunction is based on a correlation between a change over time of a value which is a measurement result of measurement by a second sensor among the plurality of sensors and a change over time of a value which is a measurement result of measurement by a third sensor different from the second sensor among the plurality of sensors, the display mode is determined such that (i) the change over time of the value which is the measurement result of the measurement by the second sensor and (ii) the change over time of the value which is the measurement result of the measurement by the third sensor are indicated using a graph.

For example, when the type of a malfunction is identified based on a change of the measurement result over time, a graph is assumed to be easily viewed by the user. Thus, regarding such a factor, the measurement result is displayed with a threshold value in a graph, thereby displaying data in an easy way for the user to understand.

Furthermore, for example, in the determining, when the factor in identifying the type of the malfunction is based on a comparison between a measurement result of measurement by a fourth sensor among the plurality of sensors and a measurement result of measurement by a fifth sensor different from the fourth sensor among the plurality of sensors, at a predetermined time, the display mode is determined such that (i) a value which is the measurement result of the measurement by the fourth sensor and (ii) a value which is the measurement result of the measurement by the fifth sensor are indicated using a chart.

Furthermore, for example, cooling system 300 includes a plurality of showcases connected to a same refrigerating machine, each of the plurality of showcases being the cooling equipment, and a sixth sensor among the plurality of sensors is disposed in each of the plurality of showcases, the sixth sensors measuring a same type of information. In this case, for example, in the determining, when the factor in identifying the type of the malfunction is based on a comparison result of measurement results obtained from the sixth sensors respectively disposed in the plurality of showcases, the display mode is determined such that values of the measurement results respectively obtained from the sixth sensors are indicated using a chart.

As described above, for example, when the type of a malfunction is identified based on the measurement results of the sensors at the predetermined time, the measurement results displayed in a chart are assumed to be easily viewed by the user. Thus, regarding such a factor, the measurement results are displayed in a chart, thereby displaying data in an easy way for the user to understand.

Furthermore, display control device 100 according to an aspect of the present disclosure includes: judging unit 120 that judges whether a malfunction has occurred in cooling system 300 including a plurality of sensors and cooling equipment; identifying unit 130 that identifies, when judging unit 120 judges that a malfunction has occurred in cooling system 300, a type of the malfunction based on at least one item of equipment information among items of equipment information obtained from cooling system 300 and including at least one of measurement information indicating measurement results of the plurality of sensors or setting information regarding cooling system 300; determining unit 140 that determines a display mode for the at least one item of equipment information based on at least one of the type of the malfunction or a factor in identifying the type of the malfunction;

and display control unit 150 that causes display device 200 to display (i) the at least one item of equipment information in the display mode determined by determining unit 140 and (ii) type information indicating the type of the malfunction.

Furthermore, display system 400 according to an aspect of the present disclosure includes: display control device 100; cooling system 300; and display device 200.

Accordingly, it is possible to obtain the same advantageous effect as that in the above-described display control method according to the present disclosure.

Furthermore, for example, in the above exemplary embodiment, all or part of the structural components of display control device 100, etc., may be configured using dedicated hardware or may be implemented by executing software suited to each of the structural elements. Each of the structural elements may be implemented by a program executor such as a CPU or a processor reading out and executing the software program recorded in a recording medium such as a hard disk drive (HDD) or a semiconductor memory.

### Other Embodiments

Although the display control method, etc., according to one or more aspects of the present disclosure have been described based on exemplary embodiments, the present disclosure is not limited to such embodiments. The one or more aspects may thus include forms obtained by making various modifications to the above embodiments that can be conceived by those skilled in the art, as well as forms obtained by combining structural components in different embodiments, without materially departing from the spirit of the present disclosure.

For example, display control device 100 may include a display unit (display device) such as a display. Specifically, the present disclosure may be implemented as a display device in which display control device 100 and display device 200 are formed as a single device. In this manner, the respective structural elements included in display system 400 described above may be included in an arbitrary device.

As described above, each of the above embodiments show a specific example of the present disclosure. Therefore, the numerical values, shapes, materials, structural components, the arrangement and connection of the structural components, steps, the processing order of the steps, etc., shown in the above embodiments are mere examples, and thus are not intended to limit the present disclosure.

Furthermore, for example, in the above embodiments, all or some of the structural components of display control device 100 according to the present disclosure may be implemented as dedicated hardware or may be realized by executing a software program suited to such structural components. Alternatively, the structural components may be implemented by a program executor such as a CPU or a processor reading out and executing the software program recorded in a recording medium such as an HDD or a semiconductor memory.

Furthermore, structural components of the display control device according to the present disclosure may be configured using one or more electronic circuits. The one or more electronic circuits may each be a general-purpose circuit or a dedicated circuit.

The one or more electronic circuits may include, for example, a semiconductor device, an integrated circuit (IC), a large-scale integration (LSI), etc. The IC or LSI may be integrated in a single chip or several chips. Although referred to here as IC or LSI, the name may change depending on the scale of integration, and may be referred to as a system LSI, very large-scale integration (VLSI), or ultra large-scale integration (ULSI). Furthermore, a field programmable gate array (FPGA) that can be programmed after the LSI is manufactured may be used for the same purpose.

Furthermore, general or specific aspects of the present disclosure may be implemented as a system, a device, a method, an integrated circuit, a computer program, or a non-transitory computer-readable recording medium such as an optical disc, an HDD, or a semiconductor memory on which the computer program is recorded, or may be implemented as any combination of a system, a method, an integrated circuit, a computer program, and a recording medium.

Forms obtained by making various modifications to the foregoing exemplary embodiments that can be conceived by those skilled in the art, as well as forms obtained by combining structural components in different embodiments, without materially departing from the essence of the present disclosure, are included in the present disclosure.

### INDUSTRIAL APPLICABILITY

The present disclosure can be applied to a display control device, etc., that controls a display device that presents equipment information of a cooling system to a user.

1. A display control method comprising:
judging whether a malfunction has occurred in a cooling system including a plurality of sensors and cooling equipment;
when it is judged in the judging that a malfunction has occurred in the cooling system, identifying a type of the malfunction based on at least one item of equipment information among items of equipment information including at least one of measurement information indicating measurement results of the plurality of sensors or setting information regarding the cooling system, the items of equipment information being obtained from the cooling system;
determining a display mode for the at least one item of equipment information based on at least one of the type of the malfunction or a factor in identifying the type of the malfunction; and
causing a display device to display (i) the at least one item of equipment information in the display mode determined in the determining and (ii) type information indicating the type of the malfunction.

2. The display control method according to claim 1, wherein
in the determining, the display mode is determined based on the type of the malfunction.

3. The display control method according to claim 1, wherein
in the determining, the display mode is determined based on the factor.

4. The display control method according to claim 1, wherein
the items of equipment information include items of measurement information, and
in the identifying, the type of the malfunction is identified based on at least one measurement result among the measurement results of measurements by each of the plurality of sensors.

5. The display control method according to claim 4, wherein
in the determining, when the factor is that the at least one measurement result is greater than or equal to a first threshold value, the display mode is determined such that each of (i) a type of a sensor that generated the at least one measurement result and (ii) a largest value among the at least one measurement result which is greater than or equal to the first threshold value is indicated using text characters, the sensor being included in the plurality of sensors.

6. The display control method according to claim 4, wherein
in the determining, when the factor is that the at least one measurement result is less than or equal to a second threshold value, the display mode is determined such that each of (i) a type of a sensor that generated the at least one measurement result and (ii) a smallest value among the at least one measurement result which is less than or equal to the second threshold value is indicated using text characters, the sensor being included in the plurality of sensors.

7. The display control method according to claim 4, wherein
in the determining, when the factor is that a value which is a measurement result of measurement by a first sensor among the plurality of sensors does not reach a third threshold value within a first predetermined period, the display mode is determined such that (i) each of values of measurement results of measurements by the first sensor within the first predetermined period and (ii) the third threshold value are indicated using a graph.

8. The display control method according to claim 4, wherein
in the determining, when the factor is based on a correlation between a change over time of a value which is a measurement result of measurement by a second sensor among the plurality of sensors and a change over time of a value which is a measurement result of measurement by a third sensor different from the second sensor among the plurality of sensors, the display mode is determined such that (i) the change over time of the value which is the measurement result of the measurement by the second sensor and (ii) the change over time of the value which is the measurement result of the measurement by the third sensor are indicated using a graph.

9. The display control method according to claim 4, wherein
in the determining, when the factor is based on a comparison between a measurement result of measurement by a fourth sensor among the plurality of sensors and a measurement result of measurement by a fifth sensor different from the fourth sensor among the plurality of sensors, at a predetermined time, the display mode is determined such that (i) a value which is the measurement result of the measurement by the fourth sensor and (ii) a value which is the measurement result of the measurement by the fifth sensor are indicated using a chart.

10. The display control method according to claim 4, wherein
the cooling system includes a plurality of showcases connected to a same refrigerating machine, each of the plurality of showcases being the cooling equipment,
a sixth sensor among the plurality of sensors is disposed in each of the plurality of showcases, the sixth sensors measuring a same type of information, and
in the determining, when the factor is based on a comparison result of measurement results obtained from the sixth sensors respectively disposed in the plurality of showcases, the display mode is determined such that values of the measurement results respectively obtained from the sixth sensors are indicated using a chart.

11. A display control device comprising:
a judging unit that judges whether a malfunction has occurred in a cooling system including a plurality of sensors and cooling equipment;
an identifying unit that identifies, when the judging unit judges that a malfunction has occurred in the cooling system, a type of the malfunction based on at least one item of equipment information among items of equipment information including at least one of measurement information indicating measurement results of the plurality of sensors or setting information regarding the cooling system, the items of equipment information being obtained from the cooling system;
a determining unit that determines a display mode for the at least one item of equipment information based on at least one of the type of the malfunction or a factor in identifying the type of the malfunction; and
a display control unit that causes a display device to display (i) the at least one item of equipment information in the display mode determined by the determining unit and (ii) type information indicating the type of the malfunction.

12. A display system comprising:
the display control device according to claim 11;
the cooling system; and
the display device.
